(19) United States
(12) Patent Application Publication
(10) Pub. No.: US 2025/0380729 A1
(43) Pub. Date: Dec. 18, 2025

(54) COMPLETE DISSOLUTION OF DRIED WHOLE EGG IN FORMIC AND/OR NITRIC ACID AND USE OF THE RESULTING SOLUTION IN THE FOOD INDUSTRY AND FOR RESEARCH IN HUMAN NUTRITION

(71) Applicant: Wisconsin Alumni Research Foundation, Madison, WI (US)

(72) Inventors: Michael Sussman, Cross Plains, WI (US); Jamison Wolfer, Cross Plains, WI (US); Heather Burch, Lone Rock, WI (US); Benjamin Minkoff, Madison, WI (US)

(73) Assignee: Wisconsin Alumni Research Foundation, Madison, WI (US)

(21) Appl. No.: 18/877,340

(22) PCT Filed: Jun. 23, 2023
(86) PCT No.: PCT/US2023/026053

§ 371 Date: Dec. 20, 2024

Related U.S. Application Data
(60) Provisional application No. 63/355,282, filed on Jun. 24, 2022.

(51) Int. Cl. A23L 15/00; A21D 13/24; A21D 13/26; A21D 13/28; A23L 5/00

(52) U.S. Cl. CPC A23L 15/00; A21D 13/24; A21D 13/26; A21D 13/28; A23L 5/55

(57) ABSTRACT

A composition of matter including dried whole eggs and/or lyophilized whole eggs dissolved in a solvent comprising formic acid, nitric acid, or a combination of formic and nitric acid, and a method of making the same.

### CROSS-REFERENCE TO RELATED APPLICATIONS

Priority is claimed to U.S. provisional application Ser. No. 62/355,282, filed Jun. 24, 2022, which is incorporated herein by reference.

### FEDERAL FUNDING STATEMENT

This invention was made with government support under HDTRA1-16-1-0049 awarded by the DOD/DTRA and under 2010789 and 1943816 awarded by the National Science Foundation and under DE-FG02-88ER13938 awarded by the US Department of Energy. The government has certain rights in the invention.

### BACKGROUND

Whole eggs comprise roughly 75% water. In contrast, freeze-dried whole eggs comprise roughly about 1.5% to about 4% water. Thus, there are great savings in transport and handling costs when using dried whole eggs as compared to the whole eggs per se. Dried egg white is a widely used product in the food and health industries. But dried whole egg (white and yolk together) has only recently emerged as a protein source in newly developed packaged food products that are high in protein content and wherein the consumers of these goods are unconcerned with the source of the protein. That is, a significant number of consumers (such as committed vegans) are extraordinarily sensitive to the sources of the proteins they consume in their diets. There is also a significant number of consumers (such as many body builders and athletes) who are completely agnostic on the subject; their concern runs to the amount of protein in their diet, rather than its source.

Whole, dried eggs can be made by several different techniques. These techniques, however, do not yield substantially identical products. Until the early 1950's, essentially all dried eggs sold in the United States were made by spray drying. See, for example, U.S. Pat. No. 2,571,459, issued Oct. 16, 1951. Spray-dried whole eggs, though, tend to develop off-flavors if not carefully stored at relatively mild, ambient temperatures. More recently, the industry has turned to lyophilization—i.e., freeze-drying. Lyophilization yields a more thoroughly dried product, and thus a product with a longer shelf life.

When separated, egg whites and egg yolks display distinctly different characteristics when lyophilized. The residual moisture in egg whites, post-freeze drying, depends at least in part upon the concentration of albumen (i.e., ovalbumin) in the whites and the temperature of the processing. Egg whites containing 80% albumen and lyophilized at −7° C. can have moisture levels as high as 6.4%. In contrast, yolks simply dried at 66° C. have residual moisture of 0.2%. Whites, whole eggs, and yolks lyophilized at 3° C. had residual moisture levels of 5.21%, 1.57%, and 0.83%, respectively. See Cotterill and Glaubert (1975) “Residual Moisture in Freeze-Dried Egg Mixtures,” Poultry Science 54:1320-1322.

Dried whole eggs in the form of small spherical “beads” produced through a fluidized bed dryer are a shelf-stable dehydrated egg product that differs from traditional dry powdered eggs. Egg powders are produced through spray-drying or lyophilization and sometimes involve a fermentation process that removes glucose from the eggs to prevent a brown discoloration via the Maillard reaction. (Lechevalier, V., Nau, F., & Jeantet, R. (2013). Powdered egg. Handbook of Food Powders: Processes and Properties, 255, 484-512.) Egg powders (and/or egg “crystals”) may also undergo an ultra-filtration process that removes some water from the egg white prior to a drying step. Because this process also removes small molecules from the egg white, the overall composition is modified, possibly removing nutritional value from the final product. (Froning, G. W., Wehling, R. L., Ball, H. R., & Hill, R. M. (1987). Effect of Ultrafiltration and Reverse-Osmosis on the Composition and Functional-Properties of Egg-White. Poultry Science, 66(7), 1168-1173.) These fermentation and filtration steps are not required in the production of egg beads, thus making them a good candidate for experimentation as there is little modification to the overall composition of the eggs during the drying process, and the product is shelf stable and commercially available.

The egg bead process begins, like other drying methods, with breaking the eggs and mixing the yolk and whites together, followed by pasteurization, performed under aseptic conditions at a minimum temperature in order to limit damage or modification to the eggs. After pasteurization, the egg suspension mixture is sprayed and then dried in a fluidized bed dryer. This method uses a relatively large volume of air to dry the beads at a lower temperature (˜70° C.), thus minimizing discoloration and modification due to oxidation and the Maillard reaction. About 12.5 g of egg beads is equivalent to an average large-sized 50 g egg (not including shell weight).

The nutritional value of chicken eggs has been well documented. (Rehault-Godbert, S., Guyot, N., & Nys, Y. (2019). The Golden Egg: Nutritional Value, Bioactivities, and Emerging Benefits for Human Health. Nutrients, 11(3).) Eggs are an excellent source of protein and minerals, provide all the essential vitamins except for vitamin C, and contain a high ratio of unsaturated to saturated fatty acids (Sunwoo, H. H., & Gujral, N. (2015). Chemical Composition of Egg and Egg Products. In P. C. K. Cheung (Ed.), Handbook of Food Chemistry (pp. 1-27). Berlin, Heidelberg: Springer Berlin Heidelberg.). In recent years there has been an increased interest in the health benefits of choline, including its role as an important pre-natal essential nutrient. (Korsmo, H. W., Jiang, X. Y., & Caudill, M. A. (2019). Choline: Exploring the Growing Science on Its Benefits for Moms and Babies. Nutrients, 11(8).) Several recent studies have demonstrated that in rats and mice, insufficient supply of choline during pregnancy is deleterious for proper development of mammalian neural tissue. Because the neurotransmitter acetylcholine (as well as phosphatidylcholine, the major component of the lipidic permeability barrier in plasma membrane of all cells) are both derived from dietary choline sources, it is not surprising that potentially irreversible behavioral disorders due to nerve dysfunction are observed in progeny of choline-starved rodent mothers. (Zeisel, S. H. (2006). The fetal origins of memory: The role of dietary choline in optimal brain development. Journal of Pediatrics, 149(5), S131-S136.) Eggs are one of the best dietary sources of choline, providing 115 to 150 mg choline per large whole egg, via the phosphatidylcholine present in yolk. In addition, this “natural” form of choline (derived from phosphatidylcholine) has been reported to be a better source of choline than choline bitartrate supplements. (Smolders, L., de Wit, N. J. W., Balvers, M. G. J., Obeid, R., Vissers, M. M. M., & Esser, D. (2019). Natural Choline from Egg Yolk Phospholipids Is More Efficiently Absorbed Compared with Choline Bitartrate; Outcomes of A Randomized Trial in Healthy Adults. Nutrients, 11(11).) Given the emerging importance of choline for proper human development, and eggs in general as a major source of choline available in the food industry, new methods to characterize and quantify the composition of eggs will be valuable for scientific study, as well as for the food industry.

Lipids play many roles in biology including structural components of cell membranes, absorption of fat-soluble vitamins, and transport. In chicken eggs, the lipids are primarily located in the yolk and, in general, are made up of 66% triacylglycerols, 28% phospholipids, and 6% cholesterol (Belitz, H D., Grosch, W., Schieberle, P. (2004). Eggs. In: Food Chemistry. Springer, Berlin, Heidelberg. doi.org/10.1007/978-3-662-07279-0_12.) Mass spectrometry-based lipidomic profiling is a rapidly growing field that has numerous applications in food science, as well as the food industry. (Song, Y., Cai, C., Song, Y., Sun, X., Liu, B., Xue, P., Zhu, M., Chai, W., Wang, Y., Wang, C., & Li, M. (2022). A Comprehensive Review of Lipidomics and Its Application to Assess Food Obtained from Farm Animals. Food Sci Anim Resour, 42(1), 1-17.) Although mass spectrometry (“MS”) is a very powerful, high-resolution tool, it has a few disadvantages. For example, the need for prior extraction to prevent instrument performance degradation increases time and resources needed upfront. Also, because MS requires charged molecules, some are never observed due to lack of charging or, for HPLC-MS, because they display poor chromatographic behavior prior to analysis.

Egg yolks are made up of about 17% protein and about 47% water; egg whites are about 10% protein and about 88% water. Ovalbumin is the most abundant protein in eggs, representing ˜54% of the total protein. (Mann, K. (2017). Proteomics of Egg White. Proteomics in Food Science: From Farm to Fork, 261-276.) Previous MS-based proteomic analyses have focused on the yolk or white and yolk sac membranes separately.

A major benefit of nuclear magnetic resonance (NMR) spectroscopy is that it does not require purification or separation steps prior to analysis. This is especially advantageous in food science research because complex molecular mixtures are the norm, rather than the exception. Recently, ³¹P-NMR has been utilized for lipid analysis of egg yolks and mayonnaise. Mayar, M., de Roo, N., Hoos, P., & van Duynhoven, J. (2020). P-31 NMR Quantification of Phospholipids and Lysophospholipids in Food Emulsions. Journal of Agricultural and Food Chemistry, 68(17), 5009-5017. The analysis, however, was conducted only after extensive extraction was performed. As disclosed hereinbelow, a method of the present disclosure dissolves whole dried egg in formic acid and/or nitric acid which can be used directly, without extraction, in an NMR tube, to ensure that there is no loss of components. An advantage of NMR, compared to all other analytical tools, is that the entire population of molecules is interrogated via nondestructive use of electromagnetic radiation. While NMR is excellent for homogenous mixtures of small molecules and even small proteins, it does not provide useful information for mixtures of proteins. Even with purified protein sample, NMR's utility for structural data is limited to small proteins, generally under 35,000 Da and requires isotopic enrichment via growth in E. coli, with ¹⁵N and ¹³C, adding further complexity and the special handling required when using radioactive isotopes.

For proteomic analyses, mass spectrometry is a powerful tool for the evaluation of complex mixtures and has proven to be the foundation of many emerging fields in the “omics” era. (Zaikin, V. G., & Borisov, R. S. (2021). Mass Spectrometry as a Crucial Analytical Basis for Omics Sciences. Journal of Analytical Chemistry, 76(14), 1567-1587.) For example, although “bottom-up” proteomic procedures using proteolyzed samples provide the greatest amount of information on protein identity and both biotic and abiotic side-chain modifications, newer “top-down” procedures have emerged which can elicit critical information on the native or unfolded state of the protein. Detailed studies have been carried out for the proteomes of the egg white, egg yolk, the egg vitelline membrane, egg yolk plasma and granule, and the egg white phosphoproteome. See Mann, K., & Mann, M. (2011). In-depth analysis of the chicken egg white proteome using an LTQ Orbitrap Velos. Proteome Sci, 9(1), 7; Mann, K. (2007). The chicken egg white proteome. Proteomics, 7(19), 3558-3568. Wang, H., Qiu, N., Mine, Y., Sun, H., Meng, Y., Bin, L., & Keast, R. (2020). Quantitative Comparative Integrated Proteomic and Phosphoproteomic Analysis of Chicken Egg Yolk Proteins under Diverse Storage Temperatures. J Agric Food Chem, 68(4), 1157-1167; Mann, K. (2008). Proteomic analysis of the chicken egg vitelline membrane. Proteomics, 8(11), 2322-2332; Mann, K., & Mann, M. (2008). The chicken egg yolk plasma and granule proteomes. Proteomics, 8(1), 178-191; and Sun, Y., Jin, H., Sun, H., & Sheng, L. (2020). A Comprehensive Identification of Chicken Egg White Phosphoproteomics Based on a Novel Digestion Approach. J Agric Food Chem, 68(34), 9213-9222, respectively.

Recently, Wood et al. reported a detailed examination of egg yolk lipids, using mass spectrometric methods to identify various classes of lipids and uncovering structural details through MSMS characterization of the fatty acid chains associated with the head groups. Wood, P. L., Muir, W., Christmann, U., Gibbons, P., Hancock, C. L., Poole, C. M., Emery, A. L., Poovey, J. R., Hagg, C., Scarborough, J. H., Christopher, J. S., Dixon, A. T., & Craney, D. J. (2021). Lipidomics of the chicken egg yolk: high-resolution mass spectrometric characterization of nutritional lipid families. Poult Sci, 100(2), 887-899. Disclosed herein is a novel method that uses dried whole egg for a high-resolution tandem MS proteomic study.

### SUMMARY

Disclosed herein is a method for completely dissolving dried whole egg in a solution of formic acid, nitric acid, or a combination of formic and nitric acids. The result is a concentrated, translucent solution of whole eggs that allows for lossless analysis, manipulation, and other downstream manipulations of the component egg ingredients present in the solution. An extensive analysis of acids, bases, and organic solvents was performed for their ability to dissolve whole egg beads, egg powder, and lyophilized whole eggs. Of the various materials tested, only two-aqueous formic acid and aqueous nitric acid—were able to completely dissolve dried egg beads. The resulting solutions can be easily measured and manipulated for applications in protein labs and in the food industry.

In the food industry, there is a demand for processes that safely incorporate whole eggs into dry foods with minimal loss of nutritional value, thus this dissolution method in food-grade formic acid could be highly beneficial. The US extensively exports eggs overseas, so using dried eggs in place of fresh eggs would significantly reduce costs for air freight and refrigeration. Furthermore, formic acid is already used extensively in the food industry, so at its simplest, this disclosure enables the facile use of egg beads, which can be stored and transported almost entirely dehydrated for any food safe application using GRAS formic acid.

For example, an important problem in the packaged food industry is “soggy” bread in prepackaged sandwiches. Using the method disclosed herein, the egg/formic acid solution was sprayed onto the surface of bread slices, dried, and then canned beet slices were packaged between treated bread slices for storage overnight at 7° C. The next day, sogginess was evaluated by measuring the transfer of liquid onto a Kimwipe tissue, as a means for evaluating the efficacy of the permeability barrier created by the treatment. As seen below in the discussion of FIGS. 7A, 7B, and 7C, the treated bread transferred the least liquid onto the tissue. Similar results were obtained when the beet slices were placed between the bread for 3 days.

Thus, disclosed herein is a composition of matter comprising dried whole eggs and/or lyophilized whole eggs dissolved in a solvent comprising formic acid, nitric acid, or a combination of formic and nitric acid.

In one version, the composition of matter comprises dried whole eggs dissolved in a solvent comprising formic acid, nitric acid, or a combination of formic and nitric acid. The composition of matter may comprise dried whole eggs dissolved in a solvent comprising formic acid. The composition of matter may comprise dried whole eggs dissolved in a solvent comprising nitric acid. The solvent may include water.

In another version, the composition of matter comprises lyophilized whole eggs dissolved in a solvent comprising formic acid, nitric acid, or a combination of formic and nitric acid. The composition of matter may comprise lyophilized whole eggs dissolved in a solvent comprising formic acid. The composition of matter may comprise lyophilized whole eggs dissolved in a solvent comprising nitric acid. Again, the solvent may include water.

Also disclosed herein is a method of solubilizing dried whole eggs and/or lyophilized whole eggs, comprising dissolving the dried whole eggs and/or lyophilized whole eggs in a solvent comprising formic acid, nitric acid, or a combination of formic and nitric acid. Preferably, the formic acid and/or the nitric acid are neat. Preferred solutions include aqueous, reagent grade formic acid (≥95%, ˜25 M) and aqueous, reagent grade nitric acid (70%, ˜16 M).

Also disclosed herein is a composition of matter consisting essentially of dried whole eggs and/or lyophilized whole eggs dissolved in a solvent consisting essentially of formic acid, nitric acid, or a combination of formic and nitric acid. The solvent may further consistent essentially of water.

In one version, the composition of matter consists essentially of dried whole eggs dissolved in a solvent consisting essentially of formic acid, nitric acid, or a combination of formic and nitric acid. The composition of matter may consist essentially of dried whole eggs dissolved in a solvent consisting essentially of formic acid. The composition of matter may consist essentially of dried whole eggs dissolved in a solvent consisting essentially of nitric acid.

In another version, the composition of matter consists essentially of lyophilized whole eggs dissolved in a solvent consisting essentially of formic acid, nitric acid, or a combination of formic and nitric acid. The composition of matter may consist essentially of lyophilized whole eggs dissolved in a solvent consisting essentially of formic acid. The composition of matter may consist essentially of lyophilized whole eggs dissolved in a solvent consisting essentially of nitric acid.

Also disclosed herein is a method of solubilizing dried whole eggs and/or lyophilized whole eggs, consisting essentially of dissolving the dried whole eggs and/or lyophilized whole eggs in a solvent consisting essentially of formic acid, nitric acid, or a combination of formic and nitric acid. Preferably, the formic acid and/or the nitric acid are neat. Preferred solutions include reagent grade formic acid (≥95%, ˜25 M) and reagent grade nitric acid (70%, ˜16 M).

The objects and advantages of the disclosure will appear more fully from the following detailed description of the preferred embodiment of the disclosure made in conjunction with the accompanying drawings.

### BRIEF DESCRIPTION OF THE DRAWINGS

FIG. 1 is a pair of photographs showing the appearance of homogenized, lyophilized whole egg immediately post-freeze drying (upper panel) and after being ground to a fine powder (“LyoEgg,” lower panel).

FIG. 2 shows lyophilized whole egg powder (“LyoEgg”) dispersed in water (upper panel, left), whole egg dissolved in formic acid (upper panel, middle), and lyophilized whole egg powder dissolved in formic acid (upper panel, right). The corresponding mixtures after centrifugation are shown in the middle panel. Lyophilized whole egg powder is soluble in formic acid (middle panel, right). The egg+formic acid mixture, after 1 hour of rest and re-centrifugation, is shown in the bottom panel.

FIG. 3 is a series of photographs showing dried whole egg beads (100 mg) after being treated with 1.5 mL of acid solution. The acids tested were formic acid (≥95%), acetic acid (>99.7%), phosphoric acid (85%), nitric acid (70%), sulfuric acid (95-98%), perchloric acid (48-50%), and iso-butyric acid (99%). Only formic acid and nitric acid solubilized the dried egg beads.

FIG. 4 depicts the nitric acid and formic acid solutions shown in FIG. 3, 10 minutes after mixing with the acid solution and post-centrifugation. The nitric acid and formic acid samples yielded clear solutions, post-centrifugation, indicating that these two acids completely dissolved the dried egg beads.

FIG. 5 is a schematic diagram of the method of solubilizing whole egg beads and analyzing it as disclosed herein. Moving left-to-right through the figure, whole eggs are mixed and dried to yield dried whole egg beads. The beads are then divided into aliquots, with a portion dispersed in water (upper arrow) and a portion dissolved in aqueous formic acid (bottom arrow). The formic acid solution (being a true solution) can be directly analyzed by any number of methods, including mass spectrometry, nuclear magnetic resonance, gas chromatography, spectrophotometry, and the like. The portion dispersed in water can be extracted, for example, using chloroform/methanol, and the resulting phases individually analyzed as noted for the formic acid solution.

FIG. 6 is an exemplary mass spectrogram of phosphatidyl choline extracted from the formic acid/egg bead solution. As shown in the figure, a host of fragments of phosphatidyl choline (PC 18:2-16:0) were unambiguously identified.

FIGS. 7A, 7B, and 7C illustrate one use of the formic acid/whole egg solution to prevent sogginess of packaged bread-containing products, such as pre-packaged sandwiches. Here, canned beets were used as an exemplary, high moisture-content sandwich ingredient. The beets were placed on untreated bread (FIG. 7A), bread sprayed with aqueous formic acid (>95%) (FIG. 7B), and bread sprayed with whole lyophilized egg dissolved in formic acid (≥ 95%) (FIG. 7C). The bread was allowed to rest at 7° C. for 24 hours. The beets were then removed and the bread pressed dry with a tissue paper. The paper was then examined to see how much of the beet juice was transferred to the bread. FIG. 7C shows that the bread treated with egg beads dissolved in formic acid clearly had the least amount of liquid transferred to the bread.

FIG. 8A: egg beads and magnified view (inset); FIG. 8B: egg beads vortexed in water and then centrifuged. FIG. 8C: egg beads vortexed in formic acid and centrifuged. FIG. 8D: methanol/chloroform extraction of egg bead/formic acid solution.

FIG. 9A: ³¹P-NMR of homogenized commercial whole egg in deuterated water. FIG. 9B: ³¹P-NMR of dried egg beads dissolved in formic acid spiked with deuterated-formic acid.

FIG. 10A: Representative mass spectra of egg beads dissolved in formic acid taken in positive mode ESI-MS. FIG. 10B: representative mass spectra of egg beads dissolved in formic acid taken in negative-mode ESI-MS. Both spectra taken on an Advion-brand single quadrupole mass spectrometer (Advion, Inc., Ithaca, New York).

FIG. 11A is a representative MS spectrum of in-source fragmentation to identify the “headgroup” of a phosphatidylcholine (18:1-16:0) with a single 5 μL sample injection using standard ionization conditions. FIG. 11B is a corresponding representative MS spectrum taken under ionization conditions favoring in-source fragmentation.

### DETAILED DESCRIPTION

With the goal of fully dissolving dried whole eggs for compositional analysis, the present disclosure screened acids, bases, and organic solvents as potential candidates. Several solvents were investigated for their ability to solubilize lyophilized whole eggs. Mixing with the solvents was done manually and also automatically using vortexing and sonication as mixing techniques. Of the aqueous acids screened in this testing, only formic acid and nitric acids fully dissolved the lyophilized whole egg. Other acids that were tested, including acetic, sulfuric, hydrochloric, iso-butyric, and phosphoric acids, saturated aqueous citric acid, and perchloric acid all only partially dissolved the dried whole egg. Basic solutions of sodium hydroxide (2 M), and ammonium hydroxide (30%) also gave incomplete dissolution. The organic solvents dimethyl sulfoxide (DMSO), N,N-dimethylformamide (DMF), acetone, chloroform, and ethyl acetate gave comparable (and unsatisfactory) results.

Overall, vortexing proved a more effective method of agitation as compared to sonication or using a mechanical stir bar. Whereas 100 mg of dried whole egg was fully solubilized in 1 ml of formic acid (≥95%, ˜25 M) after 10 minutes of vortexing, 10 minutes of sonication of an identical sample resulted in only partial dissolution. Additional experiments were continued using formic acid due to its availability as a food-grade solvent, the lower level of acidity, and the possibility that nitric acid would be reactive with aromatic species, including the aromatic amino acids found in proteins. The United States Food & Drug Administration has deemed formic acid to be “generally regarded as safe” (“GRAS”) for human foodstuffs and packaging. See US FDA Select Committee on GRAS Substances (“SCOGS”) Report Number: 71, NTIS Accession Number: PB266282 (1976). In accordance with 21 CFR § 172.515, formic acid is permitted for use as a flavoring agent in foods destined for human consumption. Examples of typical concentrations of formic acid in processed foods include non-alcoholic beverages (1.0 ppm), ice-cream, ices, etc. (5.0 ppm), candy (5.0 to 18.0 ppm), baked goods (5.0 to 6.0 ppm), processed cheese (9.1 to 28.1 ppm). Formic acid is permitted by FDA for use as a food additive in the feed and drinking water of animals. See 21 CFR § 573.480.

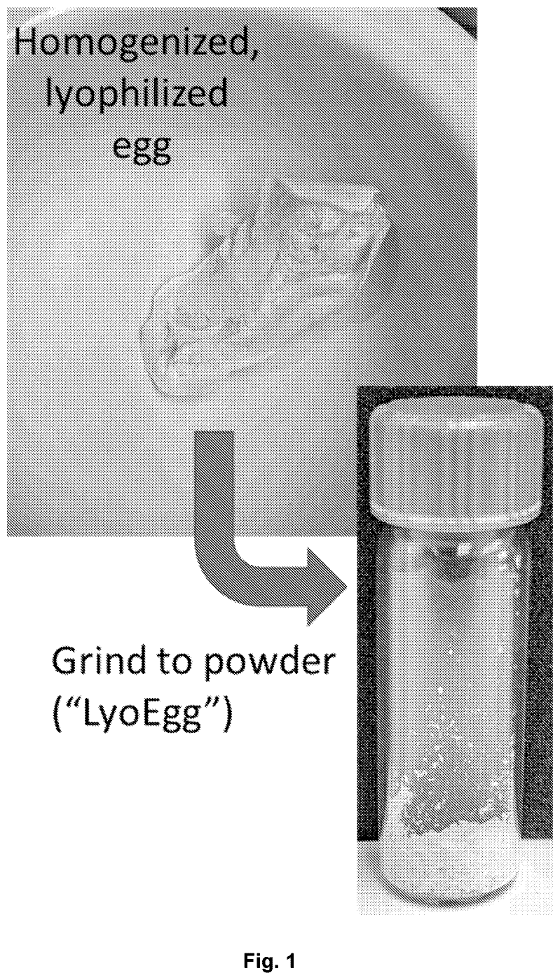

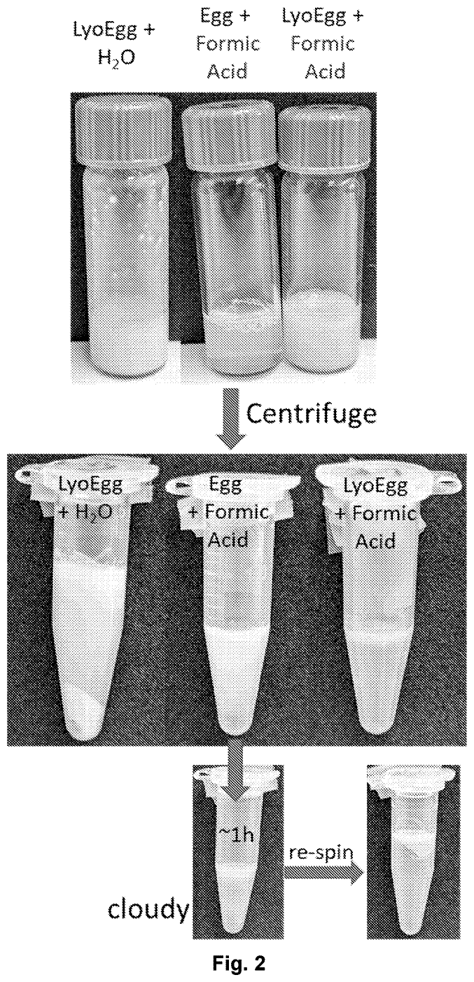

Lyophilized whole eggs are a staple article of commerce. FIG. 1 is a pair of photographs showing the appearance of homogenized, lyophilized whole egg immediately post-freeze drying (upper panel) and after being ground to a fine powder (“LyoEgg,” lower panel). This composition of matter is generally referred to herein as “egg powder.” The present method includes solubilizing egg powder using an aqueous solution of formic acid and/or nitric acid. The ability of these two acidic solutions is shown in FIG. 2, along with a comparison to attempting to solubilize egg powder using distilled water. FIG. 2 shows lyophilized whole egg powder (“LyoEgg”) dispersed in water (upper panel, left), whole egg dissolved in formic acid (upper panel, middle), and lyophilized whole egg powder dissolved in formic acid (upper panel, right). The corresponding mixtures after centrifugation are shown in the middle panel. Lyophilized whole egg powder is soluble in formic acid (middle panel, right). The egg+formic acid mixture, after 1 hour of rest and re-centrifugation, is shown in the bottom panel. As can be seen from the bottom panel of FIG. 2, the egg+formic acid mixture became cloudy after 1 hour of rest. The formic acid+egg powder and nitric acid+egg powder solutions remain clear an hour after being mixed and re-centrifuged-indicating that a true solution (rather than a suspension) has been formed.

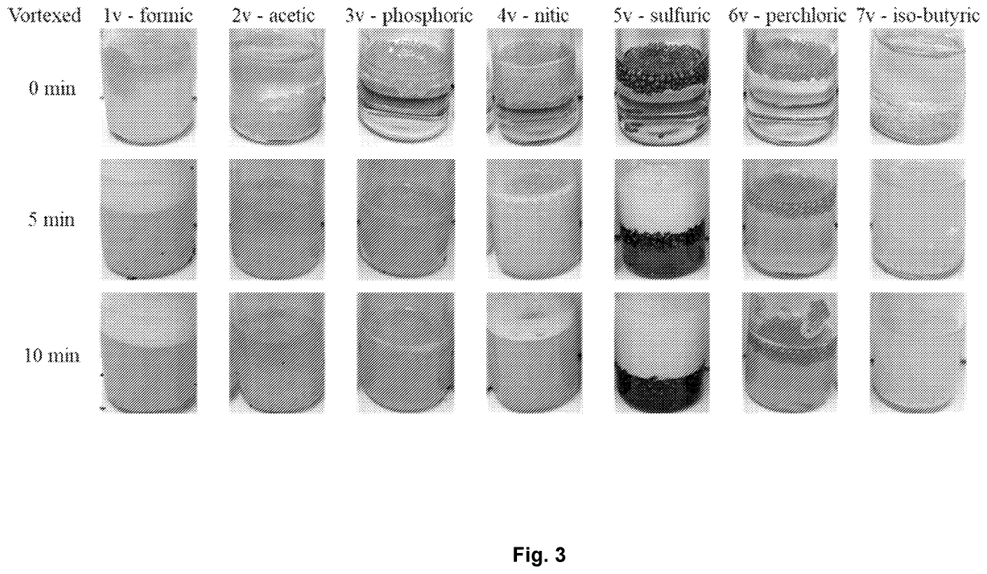

A host of other acid solutions were tested to see if they too would solubilize egg powder. Other than formic acid and nitric acid, the solutions tested are not capable of solubilizing whole egg beads. See FIG. 3, which is a series of photographs showing whole egg beads (100 mg) after being treated with 1.5 mL of the acid solutions shown. The acids tested were formic acid (≥95%), hydrochloric acid (33-38%), acetic acid (>99.7%), phosphoric acid (85%), nitric acid (70%), sulfuric acid (95-98%), perchloric acid (48-50%), and iso-butyric acid (99%). Only formic acid and nitric acid solubilized the dried whole egg beads.

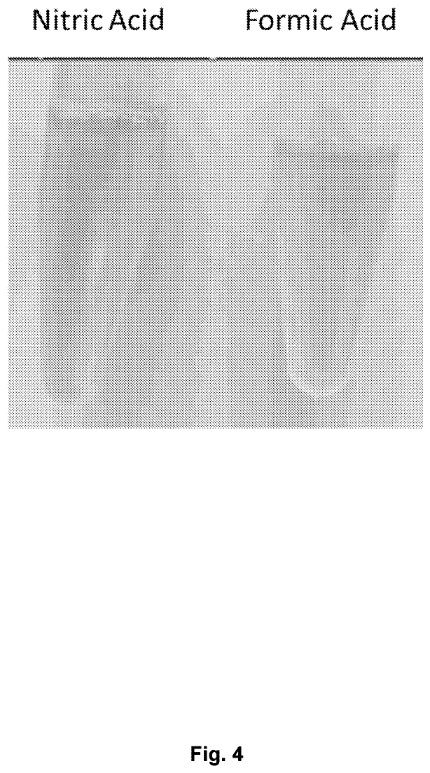

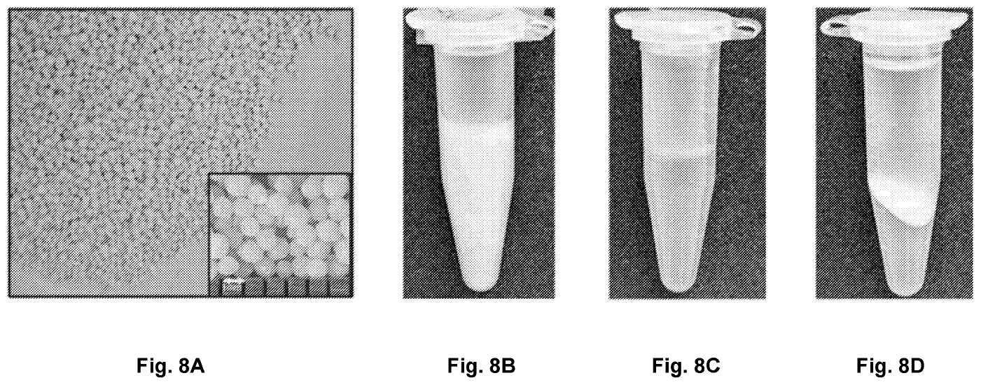

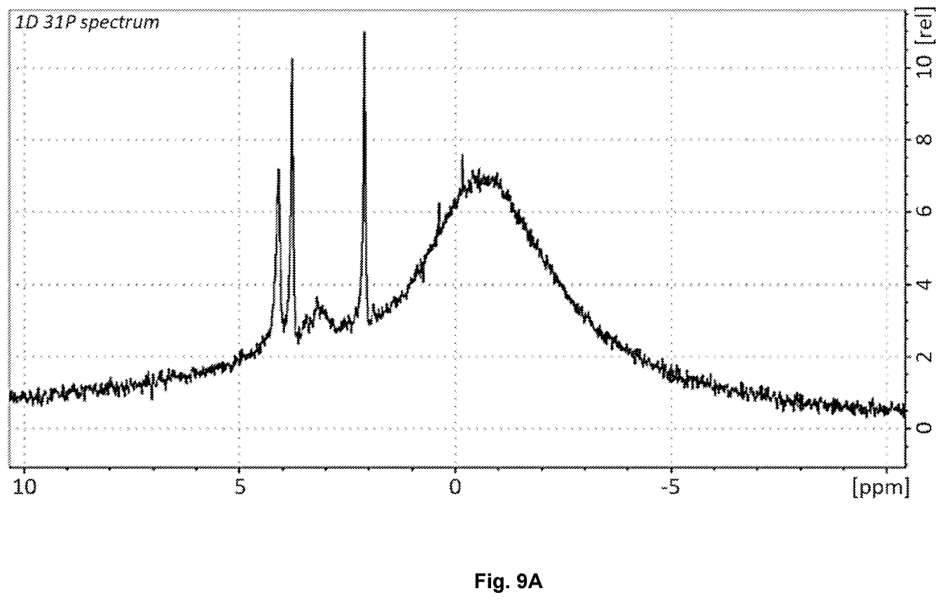

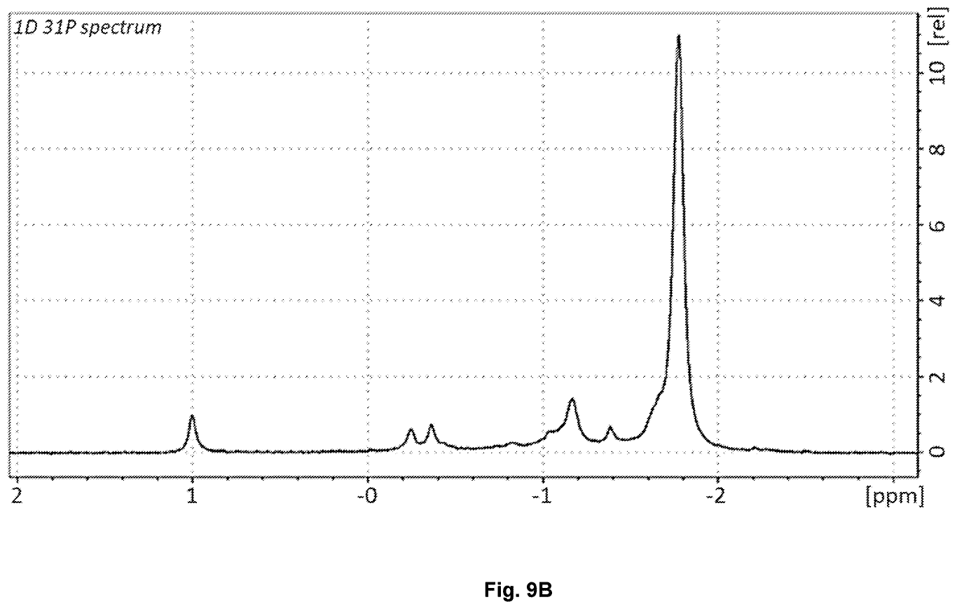

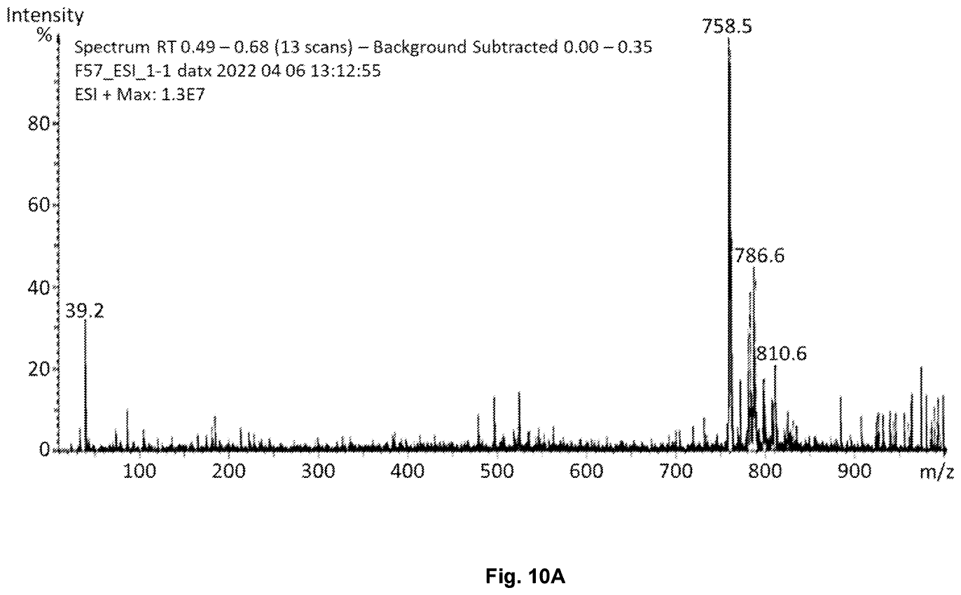

FIG. 4 depicts the nitric acid and formic acid solutions shown in FIG. 3, 10 minutes after mixing with the acid solution and post-centrifugation. As shown, the nitric acid and formic acid samples yielded clear solutions, post-centrifugation, indicating that these two acids completely dissolved the dried whole egg beads. See also FIGS. 8A-8D, which depict the egg beads prior to dissolution (FIG. 8A), the egg beads vortexed in water (FIG. 8B), the egg beads vortexed in formic acid and centrifuged (FIG. 8C; note that the solution is clear), and a methanol/chloroform extraction of the dried egg/formic acid solution (FIG. 8D). As shown in FIGS. 9A and 9B, the ³¹P-NMR spectrum of homogenized commercial whole egg in deuterated water (FIG. 9A) is distinctly broad and different from the corresponding ³¹P-NMR spectrum of dried egg beads dissolved in formic acid spiked with deuterated-formic acid (FIG. 9B). Note that FIG. 9B yields sharp, informative peaks in the ³¹P-NMR spectrum.

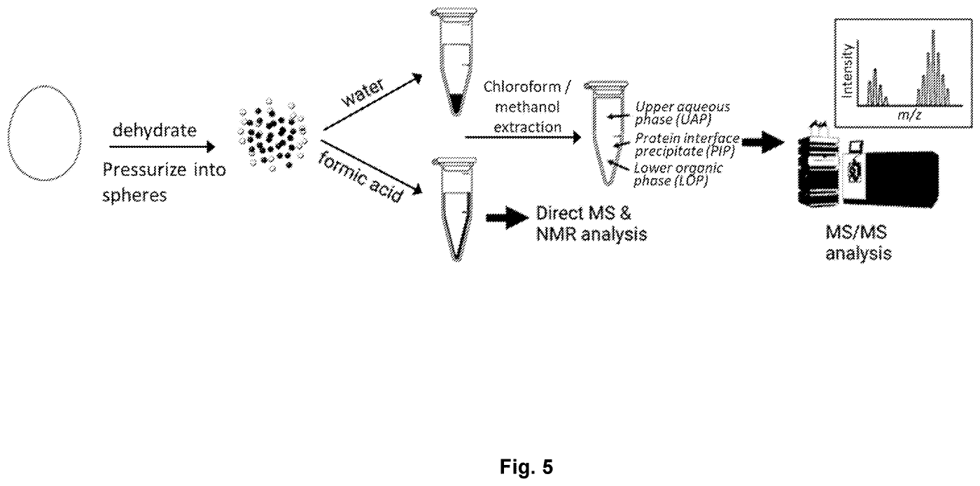

A goal of the present disclosure was to use tandem mass spectrometry to analyze lipids in a whole dried egg sample with very minimal manipulation to identify phospholipids. A parallel aim was to reconstitute the dry egg powder and to explore minimally time-consuming extraction and purification methods. In the case of dried whole egg beads, as with many other solid foodstuff samples, the ability to fully dissolve the sample is highly desirable, but often not readily obtainable. Most routine analytical methods require that the analyte be in solution. This fact, coupled with the variable solubility of sample components (i.e., proteins, lipids, small molecules) often presents a problem when trying to analyze the entire sample without loss of elements. Full dissolution of an analyte is also advantageous as a starting point for the development of separation methods to isolate components or classes of components from the sample, as well as potentially providing a new method for industrial applications in the food industry. To remedy this problem, the present disclosure discovered that formic acid and nitric acid (>95% pure) were suitable solvents in which dried egg beads could be completely dissolved, at a high enough concentration (e.g., 100 mg egg beads per ml formic or nitric acid) to allow rapid and easy downstream analyses. A goal was to use this sample directly for NMR spectroscopy and to identify lipids and proteins in the sample following a facile methanol/chloroform extraction with tandem MS. (See schematic in FIG. 5).

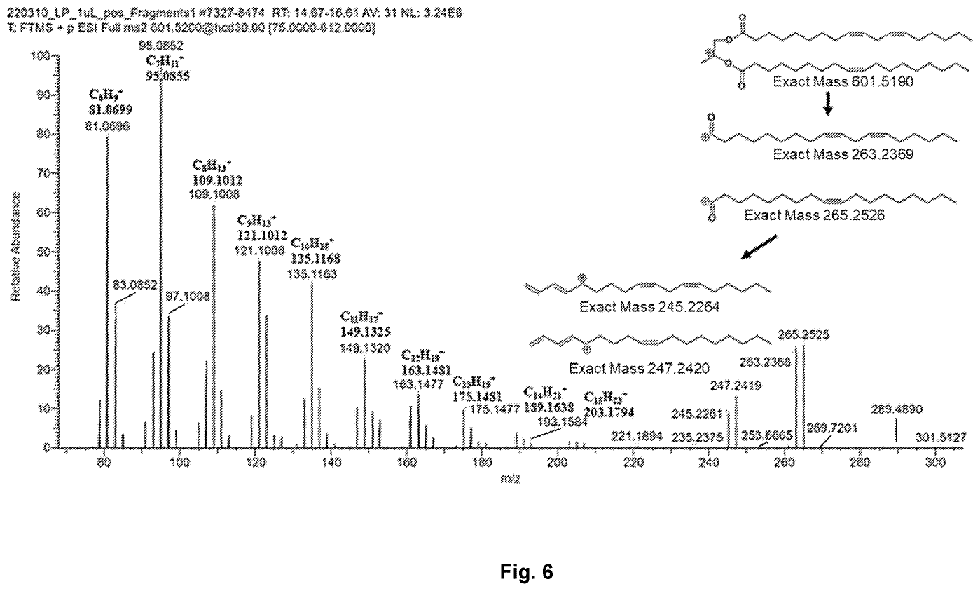

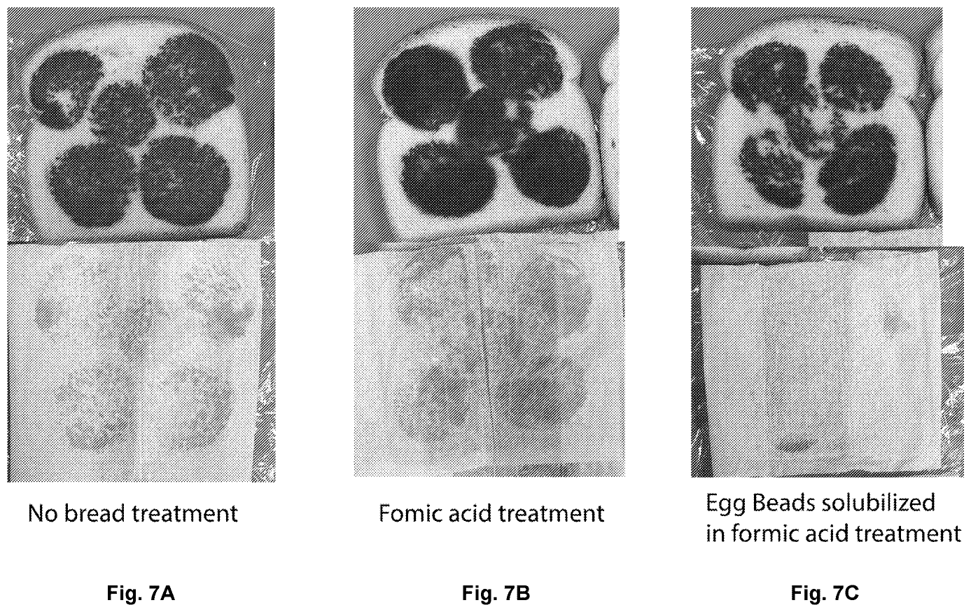

Additionally, the formic acid-dissolved whole eggs provide a homogenous solution by which whole eggs can be manipulated and applied (e.g., as a spray) onto food products. (As noted above, formic acid is a “GRAS” food ingredient.) Following a simple drying procedure in which the formic acid evaporates, a homogenous sample of whole eggs can be deposited on a surface. (See FIGS. 7A, 7B, and 7C, and the discussion below.) Formic acid is already widely used in the food industry. Thus, small amounts of residual solvent are not deleterious to health, and provide a new means of adding nutritious choline-containing products to the human diet. As shown in FIG. 5 the basic method proceeds as follows: whole eggs are mixed and lyophilized, spray dried, etc., to yield dried whole egg beads. The beads are then dissolved in aqueous formic acid (bottom arrow). The formic acid solution (being a true solution) can be directly analyzed by any number of methods, including mass spectrometry, nuclear magnetic resonance, gas chromatography, spectrophotometry, and the like. FIG. 6, for example, shows an exemplary mass spectrogram of phosphatidyl choline extracted from the formic acid/whole lyophilized egg powder solution. As shown in the figure, a host of fragments of phosphatidyl choline (PC 18:2-16:0) were unambiguously identified.

FIGS. 7A, 7B, and 7C illustrate one use of the formic acid/whole egg solution to prevent sogginess of packaged bread-containing products, such as pre-packaged sandwiches. Here, raw beets were used as an exemplary, high moisture-content sandwich ingredient. The beets were placed on untreated bread (FIG. 7A), bread sprayed with neat formic acid (FIG. 7B), and bread sprayed with whole lyophilized egg dissolved in formic acid (FIG. 7C). The bread was allowed to rest at 7° C. for 24 hours and also 3 days. The beets were then removed and the bread pressed dry with a tissue paper. The paper was then examined to see how much of the beet juice was transferred to the bread. FIG. 7C shows that the bread treated whole lyophilized egg dissolved in formic acid clearly had the list amount of liquid transferred to the bread.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the present disclosure shall include the corresponding plural characteristic or limitation, and vice-versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods of the present disclosure can comprise, consist of, or consist essentially of the essential elements and limitations of the method described herein, as well as any additional or optional ingredients, components, or limitations described herein or otherwise useful in the drying and reconstituting whole eggs. The disclosure provided herein suitably may be practiced in the absence of any element which is not specifically disclosed herein.

### Examples

### Materials and Methods

### Materials

Eggsential™ egg beads were obtained from Ovation Foods Inc. (Waterloo, WI). Mass spectrometry data were acquired on an Advion CMS with both ESI and APCI ionization sources and a Thermo Fisher Orbitrap Fusion Lumos mass spectrometer. Reagent grade formic acid (>95%) was obtained from Sigma Aldrich. Ammonium hydroxide (28-30%, Aldrich), hydrochloric acid (33-38%, Fisher), glacial acetic acid (>99.7%, Fisher), isobutyric acid (99%, Aldrich), phosphoric acid (85%, Aldrich), trifluoroacetic acid (99%, Aldrich), sulfuric acid (95-98%, Fisher) perchloric acid (48-50%, Fisher), nitric acid (70%, Fisher), dimethyl sulfoxide (99.9%, Aldrich), N,N-dimethylformamide (>99.5%, Pierce) were all used without further purification. Formic acid-d2 (95 wt. % in D2O, 98% D) was purchased from Sigma Aldrich. Phosphatidylcholine standard from egg yolk was obtained from Sigma Aldrich. All other solvents and reagents are commercially available and were used without further purification.

### General Procedure for the Dissolution of Egg Beads

To a glass vial containing 100 mg of egg beads was added 1 ml of formic acid and the resulting suspension was vortexed for 10 minutes. The solution was then centrifuged for 2 minutes to ensure complete dissolution had occurred. Note: It is best to avoid plastic tubes as this may lead to contamination of the sample, as seen by MS.

### NMR Analysis

Sample preparation: A solution of egg beads (100 mg) dissolved in 1 ml of formic acid was vortexed for 10 minutes, centrifuged briefly, and 540 μl of this solution diluted with 60 μl formic acid-d2 to prepare the sample for NMR analysis. For the raw “scrambled” egg sample mixture analyzed via NMR, a whole egg was whisked to homogeneity and a portion suspended in deuterated water.

³¹P NMR spectroscopy: Spectra were obtained with a Bruker Avance III HD, 600 MHz equipped with a 5 mm cryoprobe QXI. Formic acid-d2 was used to lock and shim the instrument.

### Low-Resolution Single Quadrupole Mass Spectrometry

Sample preparation: Egg bead in formic acid solution (20 μl) prepared using the method above was added to 1 ml of running solvent which contained 4:1 acetonitrile/water with 0.1% formic acid.

Sample analysis: Low resolution mass spectrometry was carried out on an Advion expression CMS (Compact Mass Spectrometer) equipped with an electrospray ionization (ESI) source. Samples (5 μl) were introduced via direct injection. For standard ESI analysis the instrument settings were as follows: capillary temperature 250° C., source gas temperature 250° C., capillary voltage 150 V, source voltage offset 20 V, source voltage span 0 V, ESI voltage 3500 V. Settings for ESI with in-source fragmentation: capillary temperature 250° C., source gas temperature 250° C., capillary voltage 150 V, source voltage offset 20 V, source voltage span 80 V, ESI voltage 3500 V.

### MS/MS Analysis of Upper and Lower Phase of Egg Bead Extraction

Methanol/chloroform extraction procedure: Egg beads (100 mg) were added to a glass vial and 1 ml reagent grade formic acid was added. The resulting suspension was then vortexed until completely dissolved (10 minutes). For extractions, 5 μl of the egg bead solution was added to 145 μl water. To this, 600 μl methanol was added, followed by 150 μl chloroform and 450 μl water. This mixture was centrifuged for 2 minutes and then the upper and lower phases were separated. The aqueous phase was concentrated by vacuum centrifuge to a final volume of 500 μl.

MS/MS method: Upper and lower phases of the methanol/chloroform extraction were analyzed with both positive and negative mode ESI on a Thermo Scientific Orbitrap Fusion Lumos Tribrid Mass Spectrometer. The running buffer was acetonitrile with 0.1% formic acid (MS grade) at a flow rate of 20 μl/min, and undiluted injections of 1 μL were made. Analytes were ionized with 3500V in positive mode and 2500V in negative mode, and ion transfer tube temp was set to 325° C. MS1 spectra were acquired over the range of 150-2000 m/z and peaks were picked manually in subsequent injections for MS2 fragmentation. HCD (higher-energy collisional dissociation) energy was adjusted to obtain a range of fragmentation products.

### Tandem Mass Spectrometry of Extracted Egg Protein

Protein sample preparation: The protein pellet obtained from the methanol/chloroform extraction was washed with 600 μL methanol, then 600 μL 80% acetone. The pellet was resolubilized into 8M urea/50 mM ammonium bicarbonate at pH 8.5. Sample was diluted to 4 M urea with 50 mM ammonium bicarbonate. Dithiothreitol (DTT) was added to a final concentration of 2 mM and samples were reduced for 35 minutes at 42° C., followed by alkylation with 5 mM iodoacetamide (IAA) at room temperature in the dark for 45 minutes. A second portion of 2 mM DTT was added to quench excess IAA, and samples were diluted to 1 M urea with 50 mM ammonium bicarbonate. Samples were digested at 37° C. for 12 hours with 3 μg trypsin/lys-C mix. Digest was acidified with formic acid to 1% final volume/volume and cleaned up using OMIX C18 stage tips according to manufacturer's protocol. Elutions were dried down in a vacuum centrifuge to completion. Formic acid samples were resolubilized into 20 μL 0.1% Optima LC/MS grade formic acid and water sample was resolubilized into 50 μL 0.1% Optima LC/MS grade formic acid. This was due to the inconsistency in protein pellet size post methanol/chloroform.

Mass spectrometric analysis of protein: A 2 μL sample of the formic acid solution and 1.5 μL of the water sample were used for analysis. Samples were injected onto a 75 μm×50 cm Thermo Fisher Scientific C18 Easy Spray Column with 2 μm particles and 100 Å pore size. Mobile phases used for chromatographic separation were LC/MS-grade 0.1% formic acid in water (A) and LC/MS grade 0.1% formic acid in 80% acetonitrile (B). Peptides were separated using a gradient from 5% to 37.5% B over 73 minutes, after which the column was flushed with 95% B for 5 minutes and re-equilibrated to 2% A for 10 minutes.

Peptides eluting from the column were sprayed at 1900 V into a Thermo Scientific Orbitrap Fusion Lumos Tribrid Mass Spectrometer. Data-dependent MS acquisition parameters were as follows: MS1 spectra were acquired in the Orbitrap in profile mode with a resolution of 120 K, quadrupole isolation activated, a scan range of 375-1800 m/z, an RF lens % of 30, normalized AGC target of 250%, max injection time of 50 ms. For selecting ions for fragmentation and MS2 acquisition, monoisotopic peak selection was set to peptide, charge states other than 2-7 were rejected, and dynamic exclusion was set to n=1, a duration of 10 s, and a mass tolerance of +/−10 ppm. MS spectra were acquired in the ion trap using HCD fragmentation and a fixed collision energy of 32%. Quadrupole isolation was used with the isolation window set to 0.7 m/z. A scan rate of turbo, mass range of normal, and scan range mode of auto were selected for MS acquisition, and an AGC target of 200% and max inject time of 50 ms was used. MS2 spectra were acquired in centroid mode. A cycle time of 1 s between MS1 spectra was used for data dependent acquisition.

Proteomic data analysis: Data were searched using the Sequest node of Proteome Discoverer v2.4. The Gallus gallus Uniprot database with added contaminant proteins (18,323 sequences) was searched, specifying tryptic cleavage with up to 2 missed cleavages and a precursor mass tolerance of 10 ppm, fragment mass tolerance of 0.6 Da. Variable oxidation (M), deamidation (N/Q), phosphorylation (S/T/Y), and formylation (every residue but C) were allowed. Carbamidomethylation (C) was set as static. The percolator node was used to filter resulting data with an FDR of 0.05.

### Results and Discussion

### Screening of Solvents for the Complete Dissolution of Egg Beads

With the goal of fully dissolving egg beads for compositional analysis, we began screening acids, bases, and organic solvents as potential candidates. Several solvents were considered utilizing both vortexing and sonication as mixing techniques. Of the acids screened only formic and nitric acids fully dissolved the egg beads, while acetic, sulfuric, hydrochloric, iso-butyric, phosphoric, saturated aqueous citric, and perchloric acids either provided minimal or partial dissolution of the solids. Basic solutions of sodium hydroxide (2 M), and ammonium hydroxide (30%) also gave incomplete dissolution. The organic solvents dimethyl sulfoxide (DMSO), N,N-dimethylformamide (DMF), acetone, chloroform, and ethyl acetate gave comparable, insufficient dissolution results. In formic acid, overall, vortexing proved a more effective method of agitation as compared to sonication. Whereas 100 mg of egg beads was fully solubilized in 1 ml of formic acid after 10 minutes of vortexing, 10 minutes of sonication of an identical sample resulted in only partial dissolution. We opted to continue experiments utilizing formic acid due to its volatility, availability as a food-grade solvent, the lower level of acidity, and the possibility that nitric acid may be reactive with sample components, including the aromatic amino acids found in proteins.

### ³¹P NMR Analysis of Egg Formic Acid Solution

To demonstrate the analytical advantage of whole egg in solution, we first turned to ³¹P-NMR to see if it would be possible to directly detect phospholipids. A homogenized whole egg suspended in deuterated water was chosen as a comparison for the egg beads, dissolved in formic acid and then spiked with deuterated formic acid. There is clearly higher resolution in the formic acid solution versus the homogenized whole egg. Compare FIG. 9A to FIG. 9B. The broader peaks in the homogenized egg sample are likely due to slowed molecular tumbling caused by folded native protein in the sample as compared to the fully solubilized egg bead sample in formic acid.

### Single Quadrupole Mass Spectrometry

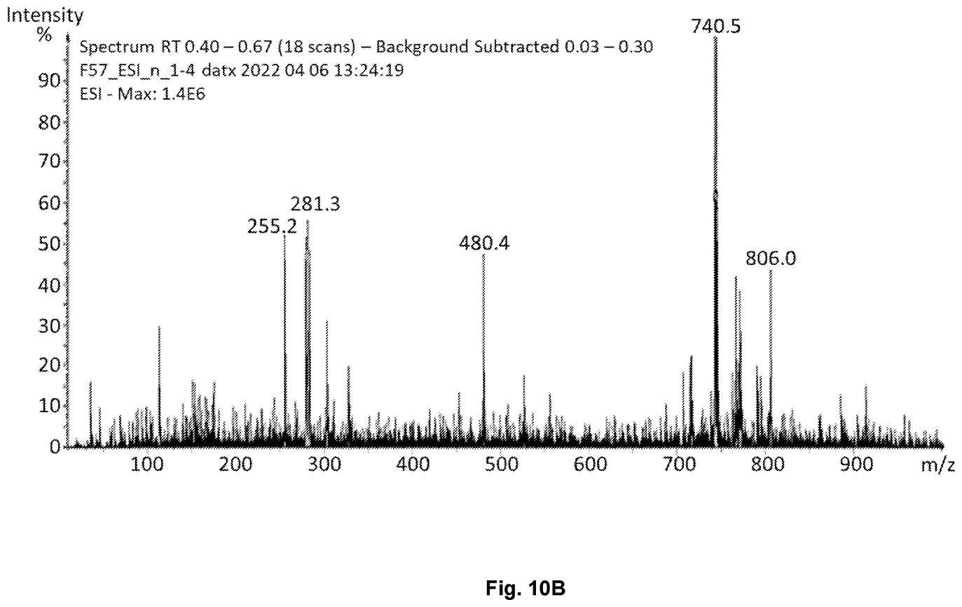

With fully dissolved egg in hand, we began mass spectrometry analysis with a single quadrupole instrument. This method of analysis has the advantage of being carried out with a fully intact solubilized egg bead sample. A diluted, but otherwise unmanipulated sample of egg beads fully dissolved in formic acid was analyzed by electrospray ionization (ESI) (see FIGS. 10A and 10B) and atmospheric pressure chemical ionization (APCI) mass spectrometry (data not shown). Due to the prevalence of in-source fragmentation observed with APCI, we chose to focus mainly on ESI-MS. The predominant peak in positive-mode ESI-MS of the formic acid solubilized egg beads was 18:1-16:0 phosphatidylcholine (m/z 760.5) with the pre-existing positive charge of the trimethylammonium head group making it highly detectable in positive-mode. Also prevalent are other phosphatidylcholines with fatty acyl ‘tail’ groups containing different degrees of unsaturation and varying chain lengths 5 (Table 1). In negative mode ESI-MS, the most abundant peaks correspond to phosphatidylethanolamines.

TABLE 1
Phospholipids identified from egg beads dissolved in formic
acid, as derived from data in FIGS. 10A and 10B.

| Phospholipid | Adduct | Observed m/z |
|---|---|---|
| PC 34:2 | [M + H]⁺ | 758.5 |
| PC 34:1 | [M + H]⁺ | 760.5 |
| PC 36:5 | [M + H]⁺ | 780.5 |
| PC 36:4 | [M + H]⁺ | 782.5 |
| PC 36:3 | [M + H]⁺ | 784.5 |
| PC 36:2 | [M + H]⁺ | 786.6 |
| PC 36:1 | [M + H]⁺ | 788.5 |
| PC 38:6 | [M + H]⁺ | 806.6 |
| PC 38:5 | [M + H]⁺ | 808.6 |
| PC 38:4 | [M + H]⁺ | 810.6 |
| PC 39:0 | [M + H]⁺ | 832.5 |
| PC 40:6 | [M + H]⁺ | 834.5 |
| PC 40:5 | [M + H]⁺ | 836.7 |
| PE 34:2 | [M − H]⁻ | 714.6 |
| PE 34:1 | [M − H]⁻ | 716.7 |
| PE 36:4 | [M − H]⁻ | 738.7 |
| PE 36:3 | [M − H]⁻ | 740.7 |
| PE 36:2 | [M − H]⁻ | 742.7 |
| PE 36:1 | [M − H]⁻ | 744.7 |
| PE 37:0 | [M − H]⁻ | 762.7 |
| PE 38:6 | [M − H]⁻ | 766.7 |
| PE 38:4 | [M − H]⁻ | 770.7 |
| PE 40:8 | [M − H]⁻ | 786.7 |
| PE 40:6 | [M − H]⁻ | 790.7 |
| PE 40:4 | [M − H]⁻ | 794.7 |
| PE 41:6 | [M − H]⁻ | 804.7 |

PC = phosphatidylcholine
PE = phosphatidylethanolamine

A total of 13 phosphatidylcholines and 13 phosphatidylethanolamines were identified via the direct injection of solubilized egg beads after dilution into the ESI running solvent, i.e. 80% acetonitrile with 0.1% formic acid (Table 1). The fact that several phosphatidylcholines were so easily identified in the sample was encouraging for future applications of the method for the quantification of total choline in eggs. Although this MS method is unable to characterize the position of the acyl chains on the glycerol backbone or the position of double bonds within the acyl chains, these structural components can be inferred since egg lipids have been well-characterized previously. The full structures of some lipids were also experimentally determined in this study via high resolution tandem MS performed on an Orbitrap based instrument, as detailed below.

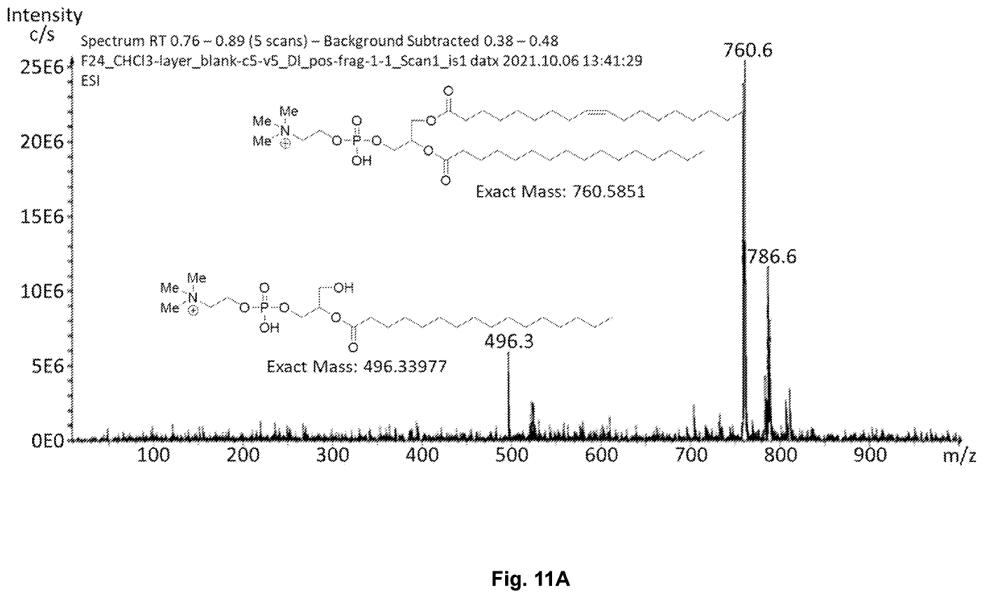

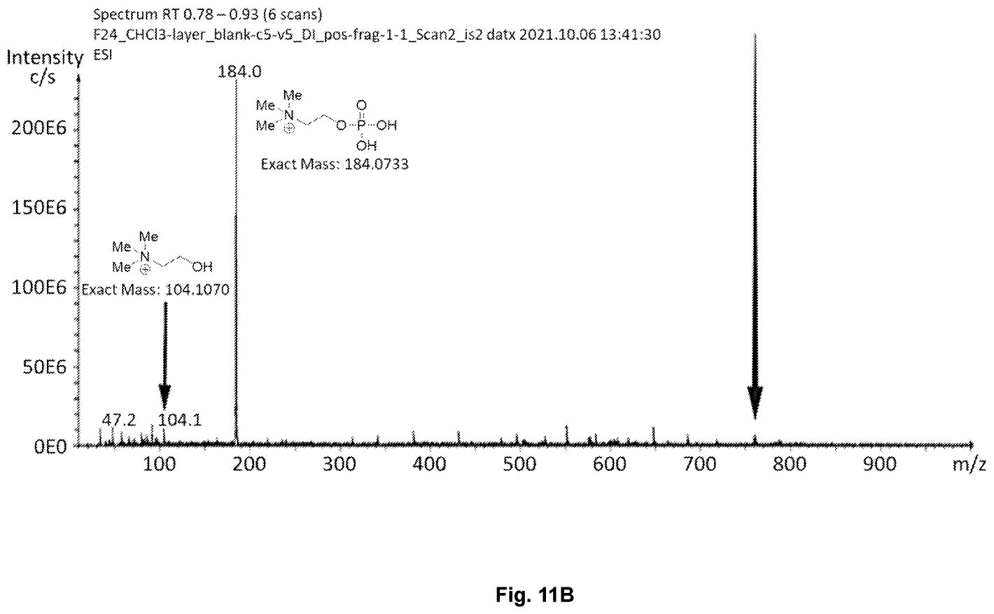

Even on this single quadrupole low resolution instrument, it was possible to identify some of the lipid classes through their corresponding headgroups, without the ability to perform MS2 fragmentation. For example, in-source ESI fragmentation could be used to identify the phosphocholine head group (m/z 184) as well as a tail fragment consisting of both fatty acyl chains (m/z 577), corresponding to PC 34:1 (m/z 760). See FIGS. 11A and 11B. Using a “source-switching” feature of the mass spectrometer it was possible to obtain the conventional and fragmentation spectra with a single injection.

Interestingly, in positive mode APCI, the major peaks at 577 and 601 are fragment ions of the PCs of molecular weight 760 and 784, which were prominent peaks observed in ESI, described above. This fragment ion likely corresponds to the loss of the entire phosphoryl choline head group. The mechanism of this fragmentation was previously postulated to be due to the loss of the trimethylammonium group, followed by subsequent loss of CH3CHO and HPO3 (Castro-Perez et al., (2011). Localization of Fatty Acyl and Double Bond Positions in Phosphatidylcholines Using a Dual Stage CID Fragmentation Coupled with Ion Mobility Mass Spectrometry. Journal of the American Society for Mass Spectrometry, 22(9), 1552-1567). The source of this fragmentation peak was verified using a commercially available phosphatidylcholine standard derived from egg yolk (data not shown).

### High Resolution Tandem Mass Spectrometry of Lipids

To obtain more detailed and comprehensive lipid composition, tandem MS analysis was employed. For this analysis a simple methanol/chloroform extraction of the egg bead/formic acid solution was performed (as illustrated schematically in FIG. 5), and the upper aqueous and lower organic phases were analyzed separately in both positive and negative mode and then peaks of interest were selected for MS2 fragmentation. The fragmentation data allowed for the characterization of lipid head and tail groups. A database containing lipids and other compounds expected to be found in eggs was manually generated and searched for structure matches. Using this method, we were able to detect 11 different classes of lipids: phosphatidylcholines, phosphatidylethanolamines, lysophosphatidylcholines, lysophosphatidylethanolamines, N-acylphosphatidylethanolamines, sphingomyelins, phosphatidylinositols, diacylglycerophosphates, cyclic phosphatidic acids, monoacylglycerides and triglycerides (Table 2). Phosphatidylcholines were detected primarily in positive mode but were also identified in negative mode as formate adducts and as fragment ions with the loss of one methyl group from the trimethylammonium headgroup (M-15). Phosphatidylethanolamines were observed exclusively in negative mode. Lysophosphatidylethanolamines were observed in positive [M+H] and negative [M−H] modes, predominately in the upper phase. Lysophosphatidylcholines were observed in positive mode in protonated form, as well as in negative mode as formate adducts and as fragments with the loss of one methyl from the trimethylammonium group. Monoacylglycerols were only observed in positive mode with the loss of water. Triglycerides were observed in positive mode as ammonium adducts, (M+18), and to a lesser extent in their protonated form. Fragmentation of the TG ammonium adducts gave rise to the corresponding diacylglyceride ions, acylium ions of the fatty acids and further breakdown of the fatty acid chains. Not surprisingly, phosphatidic acids, phosphatidylinositols, N-acylphosphatidylethanolamines, and diglycerophosphates were exclusively seen in negative mode in deprotonated form.

TABLE 2
Lipids identified in the upper and/or lower phases of a methanol/chloroform extraction
of egg beads dissolved in formic acid and the characteristic fragment ions detected.

| Lipid compound | Phase | Adduct | m/z | Observed fragment ions |
|---|---|---|---|---|
| cPA 16:0 | LP | [M − H]⁻ | 391.23 | |
| cPA 18:0 | LP | [M − H]⁻ | 419.25 | |
| cPA 18:1 | LP | [M − H]⁻ | 417.24 | |
| cPA 18:2 | LP | [M − H]⁻ | 415.23 | |
| LPC 16:0 | LP | [M + H]⁺ | 496.34 | 478, 419, 313, 258, 184, 104, 86 |
| LPC 16:0 | LP | [M + HCOOH − H]⁻ | 540.33 | 480, 255, 242, 224 |
| LPC 16:0 | UP | [M − CH₃ − H]⁻ | 480.31 | 255, 224, 168 |
| LPC 18:0 | LP | [M + H]⁺ | 524.37 | 506, 341, 258, 184, 125, 104, 86 |
| LPC 18:0 | LP | [M + HCOOH − H]⁻ | 568.36 | 508, 283, 242, 224 |
| LPC 18:1 | LP | [M + H]⁺ | 522.35 | |
| LPC 18:1 | LP | [M + HCOOH − H]⁻ | 566.35 | |
| LPC 18:2 | LP | [M + H]⁺ | 520.34 | |
| LPC 18:2 | LP | [M + HCOOH − H]⁻ | 564.33 | |
| LPC 18:3 | LP | [M + H]⁺ | 518.32 | |
| LPC 20:4 | UP, LP | [M + H]⁺ | 544.34 | |
| LPC 22:6 | UP, LP | [M + H]⁺ | 568.34 | |
| LPE 16:0 | UP | [M − H]⁻ | 452.28 | 255, 196, 97 |
| LPE 18:0 | LP | [M − H]⁻ | 480.31 | 283, 214, 196, 140 |
| LPE 18:0 | UP | [M − H]⁻ | 480.31 | 283, 196 |
| LPE 18:0 | UP, LP | [M + H]⁺ | 482.32 | |
| LPE 18:1 | UP, LP | [M + H]⁺ | 480.31 | |
| LPE 18:1 | UP, LP | [M − H]⁻ | 478.29 | |
| LPE 18:2 | UP, LP | [M − H]⁻ | 476.28 | |
| LPE 18:2 | UP, LP | [M + H]⁺ | 478.29 | |
| LPE 20:4 | LP | [M − H]⁻ | 500.28 | |
| LPE 20:4 | UP, LP | [M + H]⁺ | 502.29 | |
| LPE 22:5 | UP, LP | [M − H]⁻ | 526.28 | |
| LPE 22:6 | UP, LP | [M − H]⁻ | 524.28 | |
| LPE 22:6 | UP, LP | [M + H]⁺ | 526.29 | |
| MG 16:0 | LP | [M − H₂O + H]⁺ | 312.28 | |
| MG 18:0 | LP | [M − H₂O + H]⁺ | 341.31 | |
| MG 18:1 | LP | [M − H₂O + H]⁺ | 339.29 | |
| MG 18:2 | LP | [M − H₂O + H]⁺ | 337.27 | |
| PC 32:2 | LP | [M + H]⁺ | 730.55 | |
| PC 32:0 | LP | [M + H]⁺ | 734.57 | |
| PC 32:1 | LP | [M + H]⁺ | 732.56 | |
| PC 34:0 | LP | [M + H]⁺ | 762.59 | PC 18:0-16:0 |
| PC 18:1-16:0 | LP | [M + HCOOH − H]⁻ | 804.58 | 745, 506, 480, 281, 255, 224, 168 |
| PC 34:1 | UP | [M + H]⁺ | 760.57 | 184 |
| PC 34:1 | LP | [M + H]⁺ | 760.57 | PC 18:1-16:0 |
| PC 18:2-16:0 | LP | [M + HCOOH − H]⁻ | 802.56 | 743, 504, 480, 279, 255, 224, 168 |
| PC 34:2 | LP | [M + H]⁺ | 758.57 | 699, 575, 520, 496, 184, 125, 104, 86 |
| PC 18:2-16:0 | LP | [M − CH₃ − H]⁻ | 742.54 | 504, 480, 279, 255, 168 |
| PC 34:2 | UP | [M + H]⁺ | 758.57 | 496, 184, 104 |
| PC 34:3 | LP | [M + H]⁺ | 756.55 | |
| PC 36:1 | LP | [M + H]⁺ | 788.61 | PC 18:0-18:1 |
| PC 36:2 | LP | [M + H]⁺ | 786.60 | PC 18:0-18:2 |
| PC 36:3 | LP | [M + H]⁺ | 784.58 | |
| PC 36:4 | LP, UP | [M + H]⁺ | 782.57 | PC 16:0-20:4 |
| PC 36:5 | LP, UP | [M + H]⁺ | 780.55 | PC 16:0-20:5 |
| PC 38:3 | LP | [M + H]⁺ | 812.61 | PC 18:0-20:3 |
| PC 38:4 | LP | [M + H]⁺ | 810.60 | PC 18:0-20:4 |
| PC 38:5 | LP | [M + H]⁺ | 808.58 | |
| PC 38:6 | LP | [M + H]⁺ | 806.57 | |
| PC 40:6 | LP | [M + H]⁺ | 834.60 | |
| PE 36:1 | LP | [M − H]⁻ | 744.50 | |
| PE 18:2-18:0 | LP | [M − H]⁻ | 742.54 | 283, 279, 196, 140, 97 |
| PE 36:4 | LP | [M − H]⁻ | 738.51 | |
| PE 34:1 | LP | [M − H]⁻ | 716.53 | |
| PE 34:2 | LP | [M − H]⁻ | 714.51 | |
| PE 38:3 | LP | [M − H]⁻ | 768.55 | |
| PE 38:4 | LP | [M − H]⁻ | 766.54 | |
| PE 38:5 | LP | [M − H]⁻ | 764.53 | |
| PE 38:6 | LP | [M − H]⁻ | 762.51 | |
| PE 40:6 | LP | [M − H]⁻ | 790.54 | |
| PE 40:5 | LP | [M − H]⁻ | 792.55 | |
| PI 36:2 | LP | [M − H]⁻ | 861.55 | |
| PI 38:3 | LP | [M − H]⁻ | 887.56 | |
| PI 38:4 | LP | [M − H]⁻ | 885.55 | |
| NAPE 52:1 | LP | [M − H]⁻ | 982.78 | |
| NAPE 52:3 | LP | [M − H]⁻ | 978.75 | |
| NAPE 54:2 | LP | [M − H]⁻ | 1008.80 | |
| NAPE 54:4 | LP | [M − H]⁻ | 1004.77 | 402, 283, 279, 153 |
| (18:2, 18:2, 18:0) | | | | |
| NAPE 54:4 | LP | [M − H]⁻ | 1004.77 | 378, 303, 283, 255, 153 |
| (20:4, 18:0, 16:0) | | | | |
| NAPE 54:3 | LP | [M − H]⁻ | 1006.78 | |
| NAPE 56:5 | LP | [M − H]⁻ | 1030.78 | |
| NAPE 56:6 | LP | [M − H]⁻ | 1028.77 | |
| NAPE 56:4 | LP | [M − H]⁻ | 1032.79 | |
| NAPE 52:2 | LP | [M − H]⁻ | 980.77 | |
| NAPEp 56:6 | LP | [M − H]⁻ | 1012.79 | |
| NAPEp 56:5 | LP | [M − H]⁻ | 1014.80 | |
| PA 16:0-18:1 | LP | [M − H]⁻ | 673.48 | |
| PA 16:0-18:2 | LP | [M − H]⁻ | 671.47 | 415, 391, 279, 255, 153 |
| PA 18:0-18:1 | LP | [M − H]⁻ | 701.51 | |
| PA 18:0-18:2 | LP | [M − H]⁻ | 699.50 | 437, 433, 419, 415, 283, 279, 153, 97 |
| PA 18:1-18:2 | LP | [M − H]⁻ | 697.48 | |
| PA 18:2-18:2 | LP | [M − H]⁻ | 695.47 | |
| SM 18:1-16:0 | LP | [M + H]⁺ | 703.57 | 685, 184 |
| SM 18:1-16:0 | UP | [M + H]⁺ | 703.57 | 184, 104 |
| TG 50:2 | LP | [M + NH₄]⁺ | 848.77 | 832, 576, 552, 263, 247, 245, 239, 221 |
| TG 50:1 | LP | [M + NH₄]⁺ | 848.78 | |
| TG 50:3 | LP | [M + NH₄]⁺ | 846.75 | |
| TG 50:4 | LP | [M + NH₄]⁺ | 844.74 | |
| TG 52:2 | LP | [M + NH₄]⁺ | 876.80 | |
| TG 52:3 | LP | [M + NH₄]⁺ | 874.78 | 858, 602, 578, 576, 265, 263, 239 |
| TG 52:4 | LP | [M + NH₄]⁺ | 872.77 | |
| TG 54:2 | LP | [M + NH₄]⁺ | 904.83 | |
| TG 54:3 | LP | [M + NH₄]⁺ | 902.82 | |
| TG 54:4 | LP | [M + NH₄]⁺ | 900.80 | |
| TG 54:5 | LP | [M + NH₄]⁺ | 898.79 | |

Abbreviations:
LP = lower phase of extraction;
UP = upper phase of extraction;
cPA = cyclic phosphatiditic acid;
LPC = lysophosphatidylcholine;
LPE = lysophosphatidylethanolamine;
MG = monoacylglyceride;
PC = phosphatidylcholine;
PE = phosphatidylethanolamine;
PI = phosphatidylinositol;
NAPE = N-acetaylphosphatidylethanolamine;
PA = diacylglycerophosphate;
SM = sphingomyelin;
TG = triglyceride

We also observed several clusters of peaks toward the higher end of the m/z range that appeared to correspond to lipids but did not match known compounds or simple adducts of known compounds. With further fragmentation we discovered that these peaks belonged to dimers of lipid compounds, often as an adduct with a third charged species. For example, in negative mode, the peak at m/z 1299.91 in the lower phase sample corresponds to a formic acid adduct of a dimer consisting of phosphatidylcholine (PC 18:1-16:0) and lysophosphatidylcholine (LPE 16:0) that fragments into the PC minus a methyl group from the trimethylammonium headgroup, the formic acid adduct of the LPC and the LPC minus a methyl group.

For some phospholipids in the dataset, it was possible to use the fragmentation pattern to fully elucidate the fatty acid chains, including their length and the location of double bonds within the chain (FIG. 6). This method was previously described (Castro-Perez et al., (2011). Localization of Fatty Acyl and Double Bond Positions in Phosphatidylcholines Using a Dual Stage CID Fragmentation Coupled with Ion Mobility Mass Spectrometry. Journal of the American Society for Mass Spectrometry, 22(9), 1552-1567) using collision-induced dissociation (CID) fragmentation coupled with ion mass mobility spectrometry for phosphatidylcholines. For example, the fragment ion at m/z 601 was further fragmented to yield the 2 fatty acid chains (18:2, m/z 263 and 18:1, m/z 265). The loss of the acyl group subsequently gives rise to the fragment peaks at 245 and 247. Sequential fragmentation of these carbocations provides a characteristic peak pattern based on the chain length and the position of double bonds within the chain.

In addition to the lipids described above, seven fatty acids were detected in the lower organic phase of the extraction (Table 3). The fatty acids were readily observed in negative mode ESI in their deprotonated form and were also often seen in positive mode as fragment ions following the loss of the hydroxyl.

TABLE 3
Fatty acids detected in the organic lower phase of
the methanol/chloroform extraction, with ESI-MS.

| Fatty acid | Common name | Adduct | m/z |
|---|---|---|---|
| FA 16:0 | palmitic acid | [M − H]⁻ | 255.2 |
| FA 18:0 | stearic acid | [M − H]⁻ | 283.3 |
| FA 18:1 | oleic acid | [M − H]⁻ | 281.3 |
| FA 18:2 | linoleic acid | [M − H]⁻ | 279.2 |
| FA 20:4 | arachidonic acid | [M − H]⁻ | 303.2 |
| FA 20:0 | arachidic acid | [M − H]⁻ | 311.2 |
| FA 22:6 | docosahexaenoic acid | [M − H]⁻ | 327.2 |

### Proteomics

We next turned our attention to the egg proteome. The simple methanol/chloroform extraction of the formic acid egg bead solution allowed for the isolation of protein (FIG. 8D) free of contaminants that degrade performance of the high-resolution tandem mass spectrometer. To our knowledge there have been no previous reports of non-targeted tandem MS proteomic analysis of dried egg products and all previous studies of eggs have focused on only one component of the egg (i.e., white, yolk, or membrane).

To identify what proteins could be extracted and identified from water- and formic acid-solubilized egg beads, we analyzed their respective protein composition using bottom-up proteomics. We identified 122 proteins with high confidence when using formic acid for resolubilization, and 110 proteins when using water. Examining overlap in identification between these datasets, we found that the formic acid sample yielded 27 unique proteins (Table 4), and the water sample 15 (Table 5). Probing these subsets of proteins unique to either solvent did not reveal any obvious trends. Both Ig-like domain containing proteins and uncharacterized gene products are identified with each solvent. Overall, the data show that a slightly larger array of proteins can be extracted from formic acid solubilized egg beads compared with water, consistent with the respective solubilization vs. resuspension we visually observed. Examining the most abundant proteins identified in either sample, the list is populated by expected proteins from all egg components, demonstrating that for extraction of classic high abundance egg proteins, either solvent may be sufficient. For example, ovatransferrins, albumins, mucins, and lysozyme were identified from egg white, vitellogenins, phosvitins, and cleaved apolipoprotein B were identified from yolk, and an outer layer protein from the vitellin membrane responsible for separating the yolk from white in vivo. Consistent with egg yolk harboring immunoglobulins passed on from the mother, Ig-like domain containing proteins were identified in both samples, though only a handful in either had more than one unique identifying peptide, as expected from the combinatorial complexity of the immune system during antigen presentation.

Between both sample sets, 15 proteins with more than one unique peptide were identified that were annotated as “uncharacterized proteins” (Table 6). Of these, nine were shared between the samples, five were unique to formic acid, and one was unique to water. Most of these are annotated in Uniprot as secreted or localized in the extracellular space. Because we used formic acid and vortexing for solubilization, we probed the data to see if this solvent causes an increased level of protein formylation (+28 amu). Indeed, ˜18% of the peptides identified in the sample solubilized with formic acid had formyl group modification, the majority of which were on lysine residues, whereas ˜9% of peptides were formylated in the water solubilized samples. It appears formylation occurs primarily on the most abundant proteins within the samples (i.e., ovalbumin, ovotransferrin, phosvitin, etc.), which is consistent with the modification being introduced as a byproduct of sample processing and formic acid solubilization. In both cases, the majority of formylation occurs on lysine residues. Although not as extensively examined, the incubation of lipid standards in formic acid did not induce significant formylation.

Altogether, solubilization of egg beads into formic acid or suspension into water enables protein extraction and analysis using standard techniques. Whereas both solvents yield the most abundant set of commonly identified proteins from egg white and yolk that overlap nicely with existing literature, each also contains a unique subset of extracted proteins. Vortexing in formic acid induces an increase in protein formylation, though decreasing intensity or length of mixing may mitigate this artifact.

TABLE 4
Unique proteins identified in egg beads dissolved in formic acid.

| | | # Unique |
|---|---|---|
| Accession | Description | Peptides |
| E1BZE1 | Uncharacterized protein OS = Gallus gallus (Chicken) OX = 9031 | 4 |
| | GN = AHSG PE = 4 SV = 1 | |
| O93510 | Gelsolin OS = Gallus gallus (Chicken) OX = 9031 GN = GSN PE = 2 | 4 |
| | SV = 1 | |
| F1NDH2 | Angiotensin 1-10 OS = Gallus gallus (Chicken) OX = 9031 GN = AGT | 4 |
| | PE = 3 SV = 2 | |
| A0A1L1RZA5 | Fibrinogen C-terminal domain-containing protein OS = Gallus gallus | 4 |
| | (Chicken) OX = 9031 GN = ANGPTL3 PE = 4 SV = 2 | |
| A0A3Q2TTE0 | CTCK domain-containing protein OS = Gallus gallus (Chicken) | 4 |
| | OX = 9031 GN = ENSGALG00000047684 PE = 4 SV = 1 | |
| A0A3Q2U8Y5 | DUF4430 domain-containing protein OS = Gallus gallus (Chicken) | 3 |
| | OX = 9031 GN = TCN2 PE = 3 SV = 1 | |
| R4GLT1 | Cystatin domain-containing protein OS = Gallus gallus (Chicken) | 2 |
| | OX = 9031 GN = CST3 PE = 4 SV = 3 | |
| E1C6U2 | Uncharacterized protein OS = Gallus gallus (Chicken) OX = 9031 | 2 |
| | GN = C7 PE = 3 SV = 2 | |
| A0A3Q2UAE7 | Ig-like domain-containing protein OS = Gallus gallus (Chicken) | 2 |
| | OX = 9031 GN = ENSGALG00000047440 PE = 4 SV = 1 | |
| A0A1D5PBP6 | Uncharacterized protein OS = Gallus gallus (Chicken) OX = 9031 | 2 |
| | GN = CP PE = 3 SV = 2 | |
| P32760 | Pleiotrophin OS = Gallus gallus (Chicken) OX = 9031 GN = PTN | 2 |
| | PE = 1 SV = 2 | |
| E1C7T1 | SERPIN domain-containing protein OS = Gallus gallus (Chicken) | 2 |
| | OX = 9031 GN = SPIA1 PE = 3 SV = 1 | |
| F1NZY2 | Uncharacterized protein OS = Gallus gallus (Chicken) OX = 9031 | 1 |
| | GN = LOC395381 PE = 4 SV = 1 | |
| A0A1D5PCH3 | Mucin-6 OS = Gallus gallus (Chicken) OX = 9031 GN = MUC6 PE = 4 | 1 |
| | SV = 3 | |
| A0A3Q2TUE3 | Ig-like domain-containing protein OS = Gallus gallus (Chicken) | 1 |
| | OX = 9031 GN = ENSGALG00000047679 PE = 4 SV = 1 | |
| A0A3Q2TZA1 | Ig-like domain-containing protein OS = Gallus gallus (Chicken) | 1 |
| | OX = 9031 GN = ENSGALG00000047003 PE = 4 SV = 1 | |
| A0A3Q2UFX8 | Ig-like domain-containing protein OS = Gallus gallus (Chicken) | 1 |
| | OX = 9031 GN = ENSGALG00000053832 PE = 4 SV = 1 | |
| Q6PVZ5 | IF rod domain-containing protein OS = Gallus gallus (Chicken) | 1 |
| | OX = 9031 GN = KRT5 PE = 2 SV = 1 | |
| A0A3Q2TV88 | Ig-like domain-containing protein OS = Gallus gallus (Chicken) | 1 |
| | OX = 9031 GN = ENSGALG00000047506 PE = 4 SV = 1 | |
| A0A3Q2U0E4 | Ig-like domain-containing protein OS = Gallus gallus (Chicken) | 1 |
| | OX = 9031 GN = ENSGALG00000051946 PE = 4 SV = 1 | |
| A0A1D5PC67 | Uncharacterized protein OS = Gallus gallus (Chicken) OX = 9031 | 1 |
| | GN = C5 PE = 4 SV = 2 | |
| A0A1D5PEA7 | Uncharacterized protein OS = Gallus gallus (Chicken) OX = 9031 | 1 |
| | GN = GIF PE-3 SV = 3 | |
| P35062 | Histone H2A-III (Fragment) OS = Gallus gallus (Chicken) | 1 |
| | OX = 9031 GN = — PE = 1 SV = 2 | |
| E1C7C1 | Complement component 8 subunit beta OS = Gallus gallus | 1 |
| | (Chicken) OX = 9031 GN = C8B PE = 3 SV = 2 | |
| A0A3Q2U6K4 | Uncharacterized protein OS = Gallus gallus (Chicken) OX = 9031 | 1 |
| | GN = ENSGALG00000047120 PE = 4 SV = 1 | |
| F1NCY6 | TNFR-Cys domain-containing protein OS = Gallus gallus (Chicken) | 1 |
| | OX = 9031 GN = TNFRSF6B PE = 4 SV = 4 | |
| P00548 | Pyruvate kinase PKM OS = Gallus gallus (Chicken) OX = 9031 | 1 |
| | GN = PKM PE = 2 SV = 2 | |

TABLE 5
Unique proteins identified in egg beads extracted with water.

| | | # Unique |
|---|---|---|
| Accession | Description | Peptides |
| P01038 | Cystatin (Fragment) OS = Gallus gallus (Chicken) OX = 9031 GN = — | 5 |
| | PE = 1 SV = 2 | |
| E1BUA6 | CN hydrolase domain-containing protein OS = Gallus gallus | 3 |
| | (Chicken) OX = 9031 GN = VNN1 PE = 3 SV = 4 | |
| A0A3Q2UH03 | Ig-like domain-containing protein OS = Gallus gallus (Chicken) | 2 |
| | OX = 9031 GN = ENSGALG00000048761 PE = 4 SV = 1 | |
| F1P4F3 | ML domain-containing protein OS = Gallus gallus (Chicken) | 1 |
| | OX = 9031 GN = LY86 PE = 4 SV = 1 | |
| A0A3Q3AIA0 | Ig-like domain-containing protein OS = Gallus gallus (Chicken) | 1 |
| | OX = 9031 GN = ENSGALG00000054661 PE = 4 SV = 1 | |
| A0A3Q2TX54 | Ig-like domain-containing protein OS = Gallus gallus (Chicken) | 1 |
| | OX = 9031 GN = ENSGALG00000055104 PE = 4 SV = 1 | |
| F1NAR5 | SERPIN domain-containing protein OS = Gallus gallus (Chicken) | 1 |
| | OX = 9031 GN = SERPINF2 PE = 3 SV = 3 | |
| A0A3Q2U540 | Ig-like domain-containing protein OS = Gallus gallus (Chicken) | 1 |
| | OX = 9031 GN = ENSGALG00000049440 PE = 4 SV = 1 | |
| P41263 | Retinol-binding protein 4 OS = Gallus gallus (Chicken) OX = 9031 | 1 |
| | GN = RBP4 PE = 1 SV = 1 | |
| F1NJU5 | Uncharacterized protein OS = Gallus gallus (Chicken) OX = 9031 | 1 |
| | GN = C8A PE = 3 SV = 2 | |
| A0A1L1RWR0 | Transthyretin OS = Gallus gallus (Chicken) OX = 9031 | 1 |
| | GN = LOC112531842 PE = 3 SV = 2 | |
| A0A3Q2TRZ7 | Ig-like domain-containing protein OS = Gallus gallus (Chicken) | 1 |
| | OX = 9031 GN = ENSGALG00000051856 PE = 4 SV = 1 | |
| A0A3Q2UDA5 | Ig-like domain-containing protein OS = Gallus gallus (Chicken) | 1 |
| | OX = 9031 GN = ENSGALG00000049726 PE = 4 SV = 1 | |
| A0A1L1RWP3 | Uncharacterized protein OS = Gallus gallus (Chicken) OX = 9031 | 1 |
| | GN = DMBT1L PE = 4 SV = 2 | |

TABLE 6
Proteins identified that are annotated as uncharacterized.

| | | # Unique | |
|---|---|---|---|
| Accession | Description | Peptides | Sample |
| A0A1D5PBP6 | Uncharacterized protein OS = Gallus gallus | 2 | Formic Acid |
| | (Chicken) OX = 9031 GN = CP PE = 3 SV = 2 | | |
| A0A1L1RJ91 | Uncharacterized protein OS = Gallus gallus | 10 | Formic Acid |
| | (Chicken) OX = 9031 GN = ENSGALG00000046331 | | |
| | PE = 4 SV = 2 | | |
| A0A3Q2U3V9 | Uncharacterized protein OS = Gallus gallus | 3 | Formic Acid |
| | (Chicken) OX-9031 GN = LOC100858647 PE = 3 | | |
| | SV = 1 | | |
| E1BZE1 | Uncharacterized protein OS = Gallus gallus | 4 | Formic Acid |
| | (Chicken) OX = 9031 GN = AHSG PE = 4 SV = 1 | | |
| E1C6U2 | Uncharacterized protein OS = Gallus gallus | 2 | Formic Acid |
| | (Chicken) OX = 9031 GN = C7 PE = 3 SV = 2 | | |
| A0A1L1RNR4 | Uncharacterized protein OS = Gallus gallus | 2 | Water |
| | (Chicken) OX = 9031 GN = KNG1 PE = 4 SV = 2 | | |

A direct comparison of the data shown here with that previously published is challenging as the data sets available are now over a decade old and each used the International Protein Index (IPI), a database and accession system which was discontinued in 2011. After conversion of the IPI accession identifiers to those used here there were 129 proteins identified in the current work that were not identified in the existing non-targeted egg proteomics literature (Table 7).

As shown herein, described are the results of experiments in which formic acid is used to solubilize the molecular components of whole eggs, without first separating the yolk and white. This is made possible by removing the water from whole eggs, creating a dried material that can easily be dissolved in neat formic acid. It has further been shown that the dissolved whole egg material can be analyzed both by NMR and mass spectrometry and displays a composition of lipids and protein consistent with prior analyses performed with whites or yolks extensively extracted and fractionated in a more traditional manner. The analytical procedures, both by NMR and MS, provide new strategies for quality control analyses of biomolecules that are less cumbersome and time consuming without sacrificing the quality and resolution of analytical results. Besides advantages in the analysis of biomolecules in eggs, there are, in addition, new potential applications that this widely used volatile solvent, formic acid, could provide in the food industry. Finally, given the emerging study results that choline deprivation may be negatively affecting a significant proportion of the human population, this process provides new avenues in which the egg, a naturally rich source of choline, and other nutrients, may be more widely introduced in foods.

TABLE 7
Proteins identified in the current work that were not identified
in the existing non-targeted egg proteomics literature.

| Accession | Description |
|---|---|
| A0A0K0PUH6 | Chemerin OS = Gallus gallus (Chicken) OX = 9031 GN = RARRES2 PE = 2 SV = 1 |
| A0A140T8F5 | Ig-like domain-containing protein OS = Gallus gallus (Chicken) OX = 9031 |
| | GN = PIGR PE = 4 SV = 1 |
| A0A1D5NUW2 | Phosvitin OS = Gallus gallus (Chicken) OX = 9031 GN = VTG1 PE = 4 SV = 1 |
| A0A1D5NW68 | Albumin OS = Gallus gallus (Chicken) OX = 9031 GN = ALB PE = 4 SV = 2 |
| A0A1D5NW85 | Lipocln_cytosolic_FA-bd_dom domain-containing protein OS = Gallus gallus |
| | (Chicken) OX = 9031 GN = EXFABP PE = 3 SV = 1 |
| A0A1D5NX03 | Anion exchange protein OS = Gallus gallus (Chicken) OX = 9031 GN = SLC4A4 |
| | PE = 3 SV = 2 |
| A0A1D5P2X2 | Uncharacterized protein OS = Gallus gallus (Chicken) OX = 9031 |
| | GN = ENSGALG00000036447 PE = 4 SV = 2 |
| A0A1D5P335 | DNA_MISMATCH_REPAIR_2 domain-containing protein OS = Gallus gallus |
| | (Chicken) OX = 9031 GN = LOC101748521 PE = 3 SV = 3 |
| A0A1D5P3R8 | Uncharacterized protein OS = Gallus gallus (Chicken) OX = 9031 GN = OVST |
| | PE = 3 SV = 2 |
| A0A1D5P5V5 | C4a anaphylatoxin OS = Gallus gallus (Chicken) OX = 9031 GN = C4 PE = 4 |
| | SV = 2 |
| A0A1D5P657 | EF-hand domain-containing protein OS = Gallus gallus (Chicken) OX = 9031 |
| | GN = PPP2R3A PE = 4 SV = 2 |
| A0A1D5P6B0 | Procollagen C-endopeptidase enhancer OS = Gallus gallus (Chicken) OX = 9031 |
| | GN = ENSGALG00000033867 PE = 4 SV = 2 |
| A0A1D5P9F9 | Uncharacterized protein OS = Gallus gallus (Chicken) OX = 9031 GN = C3 PE = 4 |
| | SV = 2 |
| A0A1D5PAS6 | ZZ-type domain-containing protein OS = Gallus gallus (Chicken) OX = 9031 |
| | GN = DTNA PE = 3 SV = 2 |
| A0A1D5PBP6 | Uncharacterized protein OS = Gallus gallus (Chicken) OX = 9031 GN = CP PE = 3 |
| | SV = 2 |
| A0A1D5PC67 | Uncharacterized protein OS = Gallus gallus (Chicken) OX = 9031 GN = C5 PE = 4 |
| | SV = 2 |
| A0A1D5PCH3 | Mucin-6 OS = Gallus gallus (Chicken) OX = 9031 GN = MUC6 PE = 4 SV = 3 |
| A0A1D5PEA7 | Uncharacterized protein OS = Gallus gallus (Chicken) OX = 9031 GN = GIF |
| | PE = 3 SV = 3 |
| A0A1D5PFI1 | Protein kinase domain-containing protein OS = Gallus gallus (Chicken) |
| | OX = 9031 GN = CDKL5 PE = 4 SV = 2 |
| A0A1D5PI58 | SERPIN domain-containing protein OS = Gallus gallus (Chicken) OX = 9031 |
| | GN = OVALX PE = 3 SV = 1 |
| A0A1D5PIT4 | Lipocln_cytosolic_FA-bd_dom domain-containing protein OS = Gallus gallus |
| | (Chicken) OX = 9031 GN = PTGDS PE = 3 SV = 1 |
| A0A1D5PK48 | Apolipoprotein C-III OS = Gallus gallus (Chicken) OX = 9031 GN = APOC3 |
| | PE = 3 SV = 1 |
| A0A1D5PLZ2 | SERPIN domain-containing protein OS = Gallus gallus (Chicken) OX = 9031 |
| | GN = SERPIND1 PE = 3 SV = 1 |
| A0A1D5PME9 | Leucine rich repeat containing 15 OS = Gallus gallus (Chicken) OX = 9031 |
| | GN = ENSGALG00000046461 PE = 4 SV = 2 |
| A0A1D5PNP0 | Saposin B-type domain-containing protein OS = Gallus gallus (Chicken) |
| | OX = 9031 GN = AOAH PE = 4 SV = 2 |
| A0A1D5PNU2 | Apolipoprotein H OS = Gallus gallus (Chicken) OX = 9031 GN = APOH PE = 4 |
| | SV = 1 |
| A0A1D5PPM7 | SURF6 domain-containing protein OS = Gallus gallus (Chicken) OX = 9031 |
| | GN = SURF6 PE = 3 SV = 2 |
| A0A1D5PRH4 | Non-specific serine/threonine protein kinase OS = Gallus gallus (Chicken) |
| | OX = 9031 GN = KALRN PE = 3 SV = 2 |
| A0A1D5PSS2 | TAFH domain-containing protein OS = Gallus gallus (Chicken) OX = 9031 |
| | GN = LOC415780 PE = 3 SV = 2 |
| A0A1D5PU00 | Alpha-1-microglobulin OS = Gallus gallus (Chicken) OX = 9031 GN = AMBP |
| | PE = 3 SV = 1 |
| A0A1D5PU94 | C4a anaphylatoxin OS = Gallus gallus (Chicken) OX = 9031 GN = C4A PE = 4 |
| | SV = 1 |
| A0A1D5PW77 | Ig-like domain-containing protein OS = Gallus gallus (Chicken) OX = 9031 |
| | GN = LOC776376 PE = 4 SV = 1 |
| A0A1D5PXU4 | Uncharacterized protein OS = Gallus gallus (Chicken) OX = 9031 |
| | GN = FAM179B PE = 4 SV = 2 |
| A0A1D5PYY5 | ERA-like protein 1 OS = Gallus gallus (Chicken) OX = 9031 GN = ERAL1 PE = 3 |
| | SV = 2 |
| A0A1I7Q422 | Transthyretin OS = Gallus gallus (Chicken) OX = 9031 GN = TTR PE = 3 SV = 1 |
| A0A1L1RJ91 | Uncharacterized protein OS = Gallus gallus (Chicken) OX = 9031 |
| | GN = ENSGALG00000046331 PE = 4 SV = 2 |
| A0A1L1RNR4 | Uncharacterized protein OS = Gallus gallus (Chicken) OX = 9031 GN = KNG1 |
| | PE = 4 SV = 2 |
| A0A1L1RUE9 | Cell division cycle protein 123 homolog OS = Gallus gallus (Chicken) |
| | OX = 9031 GN = CDC123 PE = 3 SV = 1 |
| A0A1L1RWP3 | Uncharacterized protein OS = Gallus gallus (Chicken) OX = 9031 |
| | GN = DMBT1L PE = 4 SV = 2 |
| A0A1L1RWR0 | Transthyretin OS = Gallus gallus (Chicken) OX = 9031 GN = LOC112531842 |
| | PE = 3 SV = 2 |
| A0A1L1RYU0 | UPAR/Ly6 domain-containing protein OS = Gallus gallus (Chicken) OX = 9031 |
| | GN = GPIHBP1 PE = 4 SV = 1 |
| A0A1L1RZA5 | Fibrinogen C-terminal domain-containing protein OS = Gallus gallus (Chicken) |
| | OX = 9031 GN = ANGPTL3 PE = 4 SV = 2 |
| A0A1L1S0P1 | Uncharacterized protein OS = Gallus gallus (Chicken) OX = 9031 GN = PIT54 |
| | PE = 4 SV = 2 |
| A0A3Q2TRY3 | Uncharacterized protein OS = Gallus gallus (Chicken) OX = 9031 GN = CFH |
| | PE = 4 SV = 1 |
| A0A3Q2TRZ7 | Ig-like domain-containing protein OS = Gallus gallus (Chicken) OX = 9031 |
| | GN = ENSGALG00000051856 PE = 4 SV = 1 |
| A0A3Q2TTE0 | CTCK domain-containing protein OS = Gallus gallus (Chicken) OX = 9031 |
| | GN = ENSGALG00000047684 PE = 4 SV = 1 |
| A0A3Q2TTN1 | Ig-like domain-containing protein OS = Gallus gallus (Chicken) OX = 9031 |
| | GN = ENSGALG00000052542 PE = 4 SV = 1 |
| A0A3Q2TUE3 | Ig-like domain-containing protein OS = Gallus gallus (Chicken) OX = 9031 |
| | GN = ENSGALG00000047679 PE = 4 SV = 1 |
| A0A3Q2TUE5 | Ig-like domain-containing protein OS = Gallus gallus (Chicken) OX = 9031 |
| | GN = ENSGALG00000046719 PE = 4 SV = 1 |
| A0A3Q2TV88 | Ig-like domain-containing protein OS = Gallus gallus (Chicken) OX = 9031 |
| | GN = ENSGALG00000047506 PE = 4 SV = 1 |
| A0A3Q2TX54 | Ig-like domain-containing protein OS = Gallus gallus (Chicken) OX = 9031 |
| | GN = ENSGALG00000055104 PE = 4 SV = 1 |
| A0A3Q2TXP7 | Ig-like domain-containing protein OS = Gallus gallus (Chicken) OX = 9031 |
| | GN = ENSGALG00000051509 PE = 4 SV = 1 |
| A0A3Q2TYH6 | Ig-like domain-containing protein OS = Gallus gallus (Chicken) OX = 9031 |
| | GN = ENSGALG00000049267 PE = 4 SV = 1 |
| A0A3Q2TZA1 | Ig-like domain-containing protein OS = Gallus gallus (Chicken) OX = 9031 |
| | GN = ENSGALG00000047003 PE = 4 SV = 1 |
| A0A3Q2U035 | DMAP_binding domain-containing protein OS = Gallus gallus (Chicken) |
| | OX = 9031 GN = DIP2B PE = 3 SV = 1 |
| A0A3Q2U0E4 | Ig-like domain-containing protein OS = Gallus gallus (Chicken) OX = 9031 |
| | GN = ENSGALG00000051946 PE = 4 SV = 1 |
| A0A3Q2U1A2 | Ig-like domain-containing protein OS = Gallus gallus (Chicken) OX = 9031 |
| | GN = ENSGALG00000053057 PE = 4 SV = 1 |
| A0A3Q2U1N8 | Uncharacterized protein OS = Gallus gallus (Chicken) OX = 9031 GN = AKAP9 |
| | PE = 4 SV = 1 |
| A0A3Q2U287 | Ig-like domain-containing protein OS = Gallus gallus (Chicken) OX = 9031 |
| | GN = ENSGALG00000049823 PE = 4 SV = 1 |
| A0A3Q2U347 | A0A3Q2U347 Phosvitin OS = Gallus gallus (Chicken) OX = 9031 GN = VTG3 |
| | PE = 4 SV = 1 |
| A0A3Q2U3K4 | Ig-like domain-containing protein OS = Gallus gallus (Chicken) OX = 9031 |
| | GN = ENSGALG00000049747 PE = 4 SV = 1 |
| A0A3Q2U3V9 | Uncharacterized protein OS = Gallus gallus (Chicken) OX = 9031 |
| | GN = LOC100858647 PE = 3 SV = 1 |
| A0A3Q2U474 | Ig-like domain-containing protein OS = Gallus gallus (Chicken) OX = 9031 |
| | GN = ENSGALG00000049938 PE = 4 SV = 1 |
| A0A3Q2U540 | Ig-like domain-containing protein OS = Gallus gallus (Chicken) OX = 9031 |
| | GN = ENSGALG00000049440 PE = 4 SV = 1 |
| A0A3Q2U5M8 | Ig-like domain-containing protein OS = Gallus gallus (Chicken) OX = 9031 |
| | GN = ENSGALG00000047227 PE = 4 SV = 1 |
| A0A3Q2U5V5 | Ig-like domain-containing protein OS = Gallus gallus (Chicken) OX = 9031 |
| | GN = ENSGALG00000049186 PE = 4 SV = 1 |
| A0A3Q2U6K4 | Uncharacterized protein OS = Gallus gallus (Chicken) OX = 9031 |
| | GN = ENSGALG00000047120 PE = 4 SV = 1 |
| A0A3Q2U775 | Ig-like domain-containing protein OS = Gallus gallus (Chicken) OX = 9031 |
| | GN = ENSGALG00000050715 PE = 4 SV = 1 |
| A0A3Q2U7L8 | Ig-like domain-containing protein OS = Gallus gallus (Chicken) OX = 9031 |
| | GN = ENSGALG00000050545 PE = 4 SV = 1 |
| A0A3Q2U7P5 | Peptidase S1 domain-containing protein OS = Gallus gallus (Chicken) |
| | OX = 9031 GN = CFD PE = 4 SV = 1 |
| A0A3Q2U8E0 | Ig-like domain-containing protein OS = Gallus gallus (Chicken) OX = 9031 |
| | GN = ENSGALG00000050023 PE = 4 SV = 1 |
| A0A3Q2U8Y5 | DUF4430 domain-containing protein OS = Gallus gallus (Chicken) OX = 9031 |
| | GN = TCN2 PE = 3 SV = 1 |
| A0A3Q2U9M3 | Ig-like domain-containing protein OS = Gallus gallus (Chicken) OX = 9031 |
| | GN = ENSGALG00000051167 PE = 4 SV = 1 |
| A0A3Q2UAA5 | Ig-like domain-containing protein OS = Gallus gallus (Chicken) OX = 9031 |
| | GN = LOC107051274 PE = 4 SV = 1 |
| A0A3Q2UAE7 | Ig-like domain-containing protein OS = Gallus gallus (Chicken) OX = 9031 |
| | GN = ENSGALG00000047440 PE = 4 SV = 1 |
| A0A3Q2UB34 | Uncharacterized protein OS = Gallus gallus (Chicken) OX = 9031 |
| | GN = ENSGALG00000048440 PE = 4 SV = 1 |
| A0A3Q2UD25 | Uncharacterized protein OS = Gallus gallus (Chicken) OX = 9031 |
| | GN = LOC426220 PE = 3 SV = 1 |
| A0A3Q2UD70 | Ig-like domain-containing protein OS = Gallus gallus (Chicken) OX = 9031 |
| | GN = ENSGALG00000054121 PE = 4 SV = 1 |
| A0A3Q2UD89 | Uncharacterized protein OS = Gallus gallus (Chicken) OX = 9031 GN = ZNF365 |
| | PE = 4 SV = 1 |
| A0A3Q2UDA5 | Ig-like domain-containing protein OS = Gallus gallus (Chicken) OX = 9031 |
| | GN = ENSGALG00000049726 PE = 4 SV = 1 |
| A0A3Q2UFG5 | Ig-like domain-containing protein OS = Gallus gallus (Chicken) OX = 9031 |
| | GN = ENSGALG00000052804 PE = 4 SV = 1 |
| A0A3Q2UFU8 | Ig-like domain-containing protein OS = Gallus gallus (Chicken) OX = 9031 |
| | GN = ENSGALG00000048390 PE = 4 SV = 1 |
| A0A3Q2UFX3 | IGv domain-containing protein OS = Gallus gallus (Chicken) OX = 9031 |
| | GN = ENSGALG00000049010 PE = 4 SV = 1 |
| A0A3Q2UFX8 | Ig-like domain-containing protein OS = Gallus gallus (Chicken) OX = 9031 |
| | GN = ENSGALG00000053832 PE-4 SV = 1 |
| A0A3Q2UGD4 | Ig-like domain-containing protein OS = Gallus gallus (Chicken) OX = 9031 |
| | GN = ENSGALG00000047866 PE = 4 SV = 1 |
| A0A3Q2UGI5 | Ig-like domain-containing protein OS = Gallus gallus (Chicken) OX = 9031 |
| | GN = ENSGALG00000049025 PE = 4 SV = 1 |
| A0A3Q2UH03 | Ig-like domain-containing protein OS = Gallus gallus (Chicken) OX = 9031 |
| | GN = ENSGALG00000048761 PE = 4 SV = 1 |
| A0A3Q2UHC2 | Uncharacterized protein OS = Gallus gallus (Chicken) OX = 9031 |
| | GN = DENND5B PE = 3 SV = 1 |
| A0A3Q2UHF7 | A2M_recep domain-containing protein OS = Gallus gallus (Chicken) OX = 9031 |
| | GN = ENSGALG00000051209 PE = 4 SV = 1 |
| A0A3Q2UHJ5 | RAD21 cohesin complex component like 1 OS = Gallus gallus (Chicken) |
| | OX = 9031 GN = ENSGALG00000006186 PE = 3 SV = 1 |
| A0A3Q2ULW0 | Uncharacterized protein OS = Gallus gallus (Chicken) OX = 9031 |
| | GN = ENSGALG00000050720 PE = 4 SV = 1 |
| A0A3Q2UM86 | BPTI/Kunitz inhibitor domain-containing protein OS = Gallus gallus (Chicken) |
| | OX = 9031 GN = ENSGALG00000054868 PE = 4 SV = 1 |
| A0A3Q3A2R2 | Ig-like domain-containing protein OS = Gallus gallus (Chicken) OX = 9031 |
| | GN = ENSGALG00000049061 PE = 4 SV = 1 |
| A0A3Q3AGK3 | Ig-like domain-containing protein OS = Gallus gallus (Chicken) OX = 9031 |
| | GN = ENSGALG00000054874 PE = 4 SV = 1 |
| A0A3Q3AHD7 | MICOS complex subunit MIC60 OS = Gallus gallus (Chicken) OX = 9031 |
| | GN = IMMT PE = 3 SV = 1 |
| A0A3Q3AIA0 | Ig-like domain-containing protein OS = Gallus gallus (Chicken) OX = 9031 |
| | GN = ENSGALG00000054661 PE = 4 SV = 1 |
| A0A3Q3ANZ2 | Uncharacterized protein OS = Gallus gallus (Chicken) OX = 9031 |
| | GN = ENSGALG00000047480 PE = 4 SV = 1 |
| D5GR58 | Gallin protein OS = Gallus gallus (Chicken) OX = 9031 GN = gallin_2 PE = 4 |
| | SV = 1 |
| E1BQC2 | Ovotransferrin OS = Gallus gallus (Chicken) OX = 9031 GN = TF PE = 3 SV = 4 |
| E1BU01 | Non-specific serine/threonine protein kinase OS = Gallus gallus (Chicken) |
| | OX = 9031 GN = CDC42BPB PE = 3 SV = 2 |
| E1BUA6 | CN hydrolase domain-containing protein OS = Gallus gallus (Chicken) |
| | OX = 9031 GN = VNN1 PE = 3 SV = 4 |
| E1BXM5 | BPI2 domain-containing protein OS = Gallus gallus (Chicken) OX = 9031 |
| | GN = BPIFB2 PE = 4 SV = 3 |
| F1NXV6 | Activation peptide fragment 1 OS = Gallus gallus (Chicken) OX = 9031 GN = F2 |
| | PE = 4 SV = 2 |
| F1NA58 | Calponin-homology (CH) domain-containing protein OS = Gallus gallus |
| | (Chicken) OX = 9031 GN = ENSGALG00000007381 PE = 3 SV = 4 |
| Q5F4B4 | CID domain-containing protein OS = Gallus gallus (Chicken) OX = 9031 |
| | GN = RPRD1B PE = 2 SV = 1 |
| R4GLT1 | Cystatin domain-containing protein OS = Gallus gallus (Chicken) OX = 9031 |
| | GN = CST3 PE = 4 SV = 3 |
| F1NRD7 | Dickkopf-related protein 3 OS = Gallus gallus (Chicken) OX = 9031 GN = DKK3 |
| | PE = 3 SV = 1 |
| F1NUL9 | Fibrinogen beta chain OS = Gallus gallus (Chicken) OX = 9031 GN = FGB PE = 4 |
| | SV = 3 |
| F1NMK5 | Fmp27_GFWDK domain-containing protein OS = Gallus gallus (Chicken) |
| | OX = 9031 GN = KIAA0100 PE = 4 SV = 3 |
| F1NVF3 | Gc-globulin OS = Gallus gallus (Chicken) OX = 9031 GN = GC PE = 4 SV = 1 |
| F1NRM4 | Glyco_18 domain-containing protein OS = Gallus gallus (Chicken) OX = 9031 |
| | GN = CTBS PE = 3 SV = 3 |
| Q6PVZ5 | IF rod domain-containing protein OS = Gallus gallus (Chicken) OX = 9031 |
| | GN = KRT5 PE = 2 SV = 1 |
| E1C5S9 | ILEI domain-containing protein OS = Gallus gallus (Chicken) OX = 9031 |
| | GN = FAM3D PE = 3 SV = 2 |
| Q5F423 | Kinesin-like protein OS = Gallus gallus (Chicken) OX = 9031 GN = KIF3B PE = 2 |
| | SV = 1 |
| F1NB33 | Med12 domain-containing protein OS = Gallus gallus (Chicken) OX = 9031 |
| | GN = MED12L PE = 3 SV = 4 |
| F1P4F3 | ML domain-containing protein OS = Gallus gallus (Chicken) OX = 9031 |
| | GN = LY86 PE = 4 SV = 1 |
| Q5ZKU8 | p21-activated protein kinase-interacting protein 1-like OS = Gallus gallus |
| | (Chicken) OX = 9031 GN = PAK1IP1 PE = 2 SV = 1 |
| F1NIW3 | PKD_channel domain-containing protein OS = Gallus gallus (Chicken) |
| | OX = 9031 GN = MCOLN3 PE = 4 SV = 2 |
| E1BZU6 | Protein RIC1 homolog OS = Gallus gallus (Chicken) OX = 9031 GN = RIC1 |
| | PE = 4 SV = 2 |
| F1NPW9 | SMK-1 domain-containing protein OS = Gallus gallus (Chicken) OX = 9031 |
| | GN = PPP4R3A PE = 3 SV = 2 |
| F1NCY6 | TNFR-Cys domain-containing protein OS = Gallus gallus (Chicken) OX = 9031 |
| | GN = TNFRSF6B PE = 4 SV = 4 |
| Q5F3N6 | Ubiquitin carboxyl-terminal hydrolase BAP1 OS = Gallus gallus (Chicken) |
| | OX = 9031 GN = BAP1 PE = 2 SV = 1 |
| H9L0M3 | Uncharacterized protein OS = Gallus gallus (Chicken) OX = 9031 GN = ASH1L |
| | PE = 4 SV = 4 |
| E1C6U2 | Uncharacterized protein OS = Gallus gallus (Chicken) OX = 9031 GN = C7 PE = 3 |
| | SV = 2 |
| F1NPJ8 | Uncharacterized protein OS = Gallus gallus (Chicken) OX = 9031 GN = GPX3 |
| | PE = 3 SV = 3 |
| F1NWA0 | Uncharacterized protein OS = Gallus gallus (Chicken) OX = 9031 GN = HIVEP1 |
| | PE = 4 SV = 3 |
| F1NM47 | Uncharacterized protein OS = Gallus gallus (Chicken) OX = 9031 GN = LAMA1 |
| | PE = 4 SV = 4 |
| F1NZY2 | Uncharacterized protein OS = Gallus gallus (Chicken) OX = 9031 |
| | GN = LOC395381 PE = 4 SV = 1 |
| F1NV02 | Vitellogenin domain-containing protein OS = Gallus gallus (Chicken) |
| | OX = 9031 GN = APOB PE = 4 SV = 2 |

What is claimed is:

1. A composition of matter comprising dried whole eggs and/or lyophilized whole eggs dissolved in a solvent comprising formic acid, nitric acid, or a combination of formic and nitric acid.

2. The composition of matter of claim 1, comprising dried whole eggs dissolved in a solvent comprising formic acid, nitric acid, or a combination of formic and nitric acid.

3. The composition of matter of claim 2, comprising dried whole eggs dissolved in a solvent comprising formic acid.

4. The composition of matter of claim 2, comprising dried whole eggs dissolved in a solvent comprising nitric acid.

5. The composition of matter of claim 2, wherein the solvent comprises water.

6. The composition of matter of claim 1, comprising lyophilized whole eggs dissolved in a solvent comprising formic acid, nitric acid, or a combination of formic and nitric acid.

7. The composition of matter of claim 6, comprising lyophilized whole eggs dissolved in a solvent comprising formic acid.

8. The composition of matter of claim 6, comprising lyophilized whole eggs dissolved in a solvent comprising nitric acid.

9. The composition of matter of claim 6, wherein the solvent comprises water.

10. A method of solubilizing dried whole eggs and/or lyophilized whole eggs, comprising dissolving the dried whole eggs and/or lyophilized whole eggs in a solvent comprising formic acid, nitric acid, or a combination of formic and nitric acid.

11. The method of claim 10, wherein the formic acid and/or the nitric acid are neat.

12. The method of claim 10, wherein the solvent comprises water.

13. A composition of matter consisting essentially of dried whole eggs and/or lyophilized whole eggs dissolved in a solvent consisting essentially of formic acid, nitric acid, or a combination of formic and nitric acid.

14. The composition of matter of claim 13, consisting essentially of dried whole eggs dissolved in a solvent consisting essentially of formic acid, nitric acid, or a combination of formic and nitric acid.

15. The composition of matter of claim 14, consisting essentially of dried whole eggs dissolved in a solvent consisting essentially of formic acid.

16. The composition of matter of claim 14, consisting essentially of dried whole eggs dissolved in a solvent consisting essentially of nitric acid.

17. The composition of matter of claim 14, wherein the solvent further consists essentially of water.

18. The composition of matter of claim 13, consisting essentially of lyophilized whole eggs dissolved in a solvent consisting essentially of formic acid, nitric acid, or a combination of formic and nitric acid.

19. The composition of matter of claim 18, consisting essentially of lyophilized whole eggs dissolved in a solvent consisting essentially of formic acid.

20. The composition of matter of claim 18, consisting essentially of lyophilized whole eggs dissolved in a solvent consisting essentially of nitric acid.

21. The composition of matter of claim 18, wherein the solvent further consists essentially of water.

22. A method of solubilizing dried whole eggs and/or lyophilized whole eggs, consisting essentially of dissolving the dried whole eggs and/or lyophilized whole eggs in a solvent consisting essentially of formic acid, nitric acid, or a combination of formic and nitric acid.

23. The method of claim 22, wherein the formic acid and/or the nitric acid are neat.

24. The composition of matter of claim 22, wherein the solvent further consists essentially of water.
